(19) United States
(12) Patent Application Publication
(10) Pub. No.: US 2007/0061460 A1
(43) Pub. Date: Mar. 15, 2007

(54) Remote access

(75) Inventors: Irfan Z. Khan, Minneapolis, MN (US); Mitchell Y. Coopet, Inver Grove Heights, MN (US); Matthew D. Dornquast, Minneapolis, MN (US); Richard C. Baker, Mahtomedi, MN (US); Peter J. Lindquist, Saint Paul, MN (US)

Correspondence Address: BROOKS & CAMERON, PLLC, 1221 NICOLLET MALL #500, MINNEAPOLIS, MN, 55403, US

(73) Assignee: Jumpnode Systems,LLC

(21) Appl. No.: 11/598,381

(22) Filed: Nov. 13, 2006

Related U.S. Application Data
(63) Continuation-in-part of application No. 11/088,576, filed on Mar. 24, 2005.

(51) Int. Cl. G06F 15/173

(52) U.S. Cl. 709/225

(57) ABSTRACT

Systems and methods, and devices are provided for remote access. One method includes requesting access to a first device from a second device remote to the first device. The method includes processing the access request at an access hub remote to the first device. An internal node is used to open an encrypted connection to a connection manager based on the access request. Access information is provided from the access hub to the second device based on the access request. A communication session is established in which communications between the second device and the first device are forwarded through the connection manager and the internal node by using the encrypted connection.

### RELATED APPLICATIONS

The present application is a continuation in part (CIP) to a U.S. patent application Ser. No. 11/088,576, filed on Mar. 3, 2005, and entitled “NETWORK, SYSTEM, AND APPLICATION MONITORING”, the disclosure of which is incorporated in its entirety herein by reference.

### BACKGROUND

It can often be beneficial for organizations to provide remote access to private networks for various entities such as employees, partner organizations, and third party technicians, for example. Establishing a remote access link with a mobile worker or a remote business partner can allow enterprises to attain productivity gains while reducing cost. Such links can facilitate and accelerate business-to-business (B2B) transactions, provide for remote management and/or monitoring of a network, etc.

Entities wishing to access information remotely from outside a private or public network are potentially behind firewalls and other security equipment, which can prevent access to the organization's network. Such entities may not be able to remotely access information and/or remotely perform maintenance tasks without being physically connected to the organization's private network, for example, by obtaining a network address on the organization's network to physically connect to it. Also, since information can be transmitted from the organization's network, which can be private, secure, and trusted, into a public or third-party network, organizations providing such access benefit from having this information encrypted to prevent disclosure of valuable information to others.

Many private networks that allow for remote access using current remote access solutions are susceptible to security breaches. For instance, some remote access solutions include using a hardware device to which web requests are made. In such solutions, the hardware device may be exposed to hostile Internet connections since the hardware device often is “listening” for the remote access web requests and often on a permanent basis.

Also, current manners of setting up remote access to one or more of an organization's private networks can involve significant costs associated with installation of hardware devices inside the network and configuration of the hardware devices and/or a network firewall, for example. Such configuration often must be performed locally.

### BRIEF DESCRIPTION OF THE DRAWINGS

FIG. 1 is an embodiment of a network as may exist within a given company.

FIG. 2A is a block diagram of a system embodiment including an internal monitoring device connected to a company's systems, networks, and applications, and also to a remote data center.

FIG. 2B illustrates an embodiment for the electrical components of the internal monitoring device.

FIG. 3 illustrates a block diagram of a system embodiment provided to a company having multiple company offices geographically removed from one another.

FIG. 4 illustrates a block diagram of a system embodiment showing the redundancy for communicating with one or more data centers.

FIG. 5 is a block diagram of a system embodiment illustrating notification escalation and alert capabilities.

FIG. 6 is a screen shot illustrating a user interface embodiment of system, network, and application monitoring.

FIG. 7A illustrates a path diagram for a remote access communication session according to an embodiment of the present disclosure.

FIG. 7B illustrates an embodiment of communication forwarding and address mapping for a remote access communication session according to the present disclosure.

FIG. 7C illustrates an embodiment of communication forwarding and address mapping for a remote access communication session according to the present disclosure.

FIG. 8 illustrates a system for remote access according to an embodiment of the present disclosure.

FIG. 9 illustrates a system for remote access according to an embodiment of the present disclosure.

FIG. 10 illustrates a system for remote access according to an embodiment of the present disclosure.

FIG. 11 illustrates a system for remote access according to an embodiment of the present disclosure.

FIG. 12 illustrates a path diagram for a remote access communication session according to an embodiment of the present disclosure.

### DETAILED DESCRIPTION

Systems, devices, and methods are provided for system, network, and application monitoring. The methods can be performed by computer executable instructions (e.g., software, firmware, etc.) and/or logic to achieve the functionality described herein. One system embodiment includes a remote data center (maintained separate from a company's systems and networks) where administration and configuration can be performed. The system embodiment further includes an internal monitoring device, including logic and non-volatile memory, which can be attached to a company's network via standard network connections. According to embodiments, the internal monitoring device is a diskless and fanless hardware solution and can communicate with the remote data center in a stateless, i.e., without the use of a secure, continuous transaction layer, and connectionless, e.g., can use web requests according to hypertext transport protocol (HTTP), manner. The internal monitoring device is capable of monitoring the company's internal network/systems, e.g., using SNMP (simple network management protocol) to get statistics such as disk usage, processor usage, memory allocation, etc.

The internal monitoring device can record this data and update the remote data center on a periodic basis. According to embodiments, the device can compress and encrypt the data and send it to the remote data center via the Internet. According to various embodiments, if access to the Internet is interrupted, the internal monitoring device will automatically communicate by telephone line through a built in modem. If telephone line service is also interrupted, communication will be established through a built in cellular mechanism. Thus, the internal monitoring device, in various embodiments, has built-in “out of band” connectivity capabilities.

All upgrades to the device can be performed from the remote data center. For example, when a company logs into a published website of the remote data center, the administrator can reboot the devices in their network with the newest version of a flash application, which is the software which configures the devices. In other words, the hardware device can be controlled and configured over the Internet with no changes to the company's existing network, e.g., no software for the company to install. For example, the internal monitoring device can include a NAND type flash storage device which includes the operating system and which can be updated with the newest version of the software and/or operating system kernel provided from a remote source. In various embodiments, the operating system is an open source, non-Windows based solution, e.g., Linux, since Windows may be susceptible to worms and viruses.

The remote data center has the ability to receive network data from the internal device and can compile all of the information received into clear, intuitive reports and graphs that can be viewed in real time showing usage trends, system bottlenecks, etc. The remote data center has the ability to make this information viewable externally through a published website that is accessible with appropriate user IDs, passwords, etc. Thus, embodiments can provide a unified view of the entire network, both from inside and outside the network's firewall to provide an unmatched ability to pinpoint the cause of inefficiencies or failures, either within the LANs or the cables, telephone lines and satellites that link them together. Warning and alerts can be issued by via numerous means to a number of external devices such as a cell phone, laptops, PDAs, pagers, etc., and will automatically escalate notification up the company's chain of command while maintaining a record of who was responsible for what and what action was taken by whom. Logic associated with the system is built around dependencies which ascertain what has failed and what the effect is on the business, e.g., how each monitored device interrelates others in a company's network and system.

Example Company Network

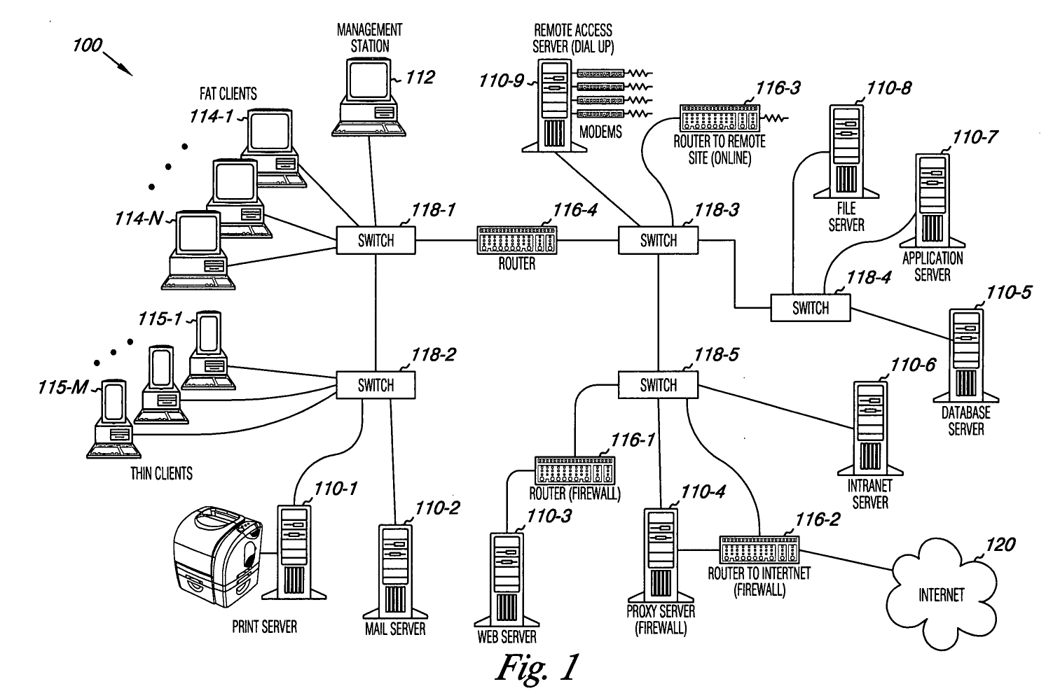

FIG. 1 is an embodiment of a network 100 as may exist within a given company. As shown in FIG. 1, a number of devices, e.g., PCs, servers, peripherals, etc., can be networked together via a local area network (LAN) (e.g., an Ethernet network), a wide area network (WAN), a wireless local area network (WLAN) the public switched telephone network (PSTN), and/or the Internet using transmission control protocol/Internet protocol (TCP/IP) via routers, hubs, switches and the like (referred to herein as “network devices”).

The embodiment of FIG. 1 illustrates clients and servers in a LAN. However, embodiments of the invention are not so limited. For example, the embodiment of FIG. 1 shows various servers for various types of services on a LAN. The example company network of FIG. 1 illustrates a print server 110-1 to handle print jobs for the network 100, a mail server 110-2, a web server 110-3, a proxy server (firewall), a database server 110-5, and intranet server 110-6, an application server 110-7, a file server 110-8, and a remote access server (dial up) 110-9. The examples provided here do not provide an exhaustive list. The example company network of FIG. 1 further illustrates a network management station 112, e.g., a PC or workstation, a number of “fat” clients 114-1, . . . , 114-N which can also include PCs and workstations and/or laptops, and a number of “thin” clients 115-1, . . . , 115-M which can include terminals and/or peripherals such as scanners, facsimile devices, handheld multifunction devices, e.g., PDAs, PC tablets, cellphones, pagers, and the like. The designators “N” and “M” are used to indicate that any number of fat or thin clients can be attached to the network 100. The number that N represents can be the same or different from the number represented by M.

The example company network of FIG. 1 illustrates that all of these example network devices can be connected to one another and/or to other networks via routers, 116-1, 116-2, 116-3, and 116-4, and hubs and/or switches 118-1, 118-2, 118-3, 118-4, and 118-5, as the same are known and understood by one of ordinary skill in the art. The network of FIG. 1 is further illustrated connected to the Internet 120 via router 116-2. As the reader will appreciate, the network 100 shown in FIG. 1 can additionally be connected to any type of radio frequency (RF) (e.g., GSM, ANSI, satellite, etc.), circuit-switched, (e.g., PSTN), and/or packet-switched network, etc. Embodiments of the invention are not limited to the number and/or type of network devices or the network architecture shown in FIG. 1's illustration.

As one of ordinary skill in the art will appreciate, many of these devices include processor and memory hardware. By way of example and not by way of limitation, the network management station 112 will include a processor and memory as the same are well known to one of ordinary skill in the art. Similarly, the network devices of routers, 116-1, 116-2, 116-3, and 116-4, hubs and/or switches 118-1, 118-2, 118-3, 118-4, and 118-5, and the number of fat clients 114-1, . . . , 1114-N and the number of thin clients 115-1, . . . , 115-M, may include processor and memory resources. Embodiments of the invention are not limited, for the various devices in the network, to the number, type or size of processor and memory resources.

Program instructions (e.g., computer executable instructions) can reside on the various network devices for performing various functionalities, performing particular tasks, or providing particular services. For example, program instructions in the form of firmware, software, etc., can be resident on the network 100 in the memory of a network management station 112, of the number of “fat” clients 114-1, . . . , 114-N, of the number of “thin” clients 115-1, . . . , 115-M, of one or more routers, 116-1, 116-2, 116-3, and 116-4, hubs and/or switches 118-1, 118-2, 118-3, 118-4, and 118-5, and such program instructions can be executed by the processor(s) thereon. As the reader will appreciate, program instructions can be resident in a number of locations on various network devices in the network 100 as employed in a distributed computing network.

Embodiments within the scope of the present invention include computer-readable media having computer-executable instructions or data fields stored thereon. Such computer-readable media can be any available media which can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to store the desired computer-executable instructions. Combinations of the above are also included within the scope of computer-readable media.

Computer-executable instructions include, for example, instructions to cause a general purpose computer, special purpose computer, or special purpose processing device to perform a certain function or group of functions, routines, etc. In some contexts, the computer-executable instructions are described as program modules being executed by processor resources within a computing device. Generally, program modules include routines, programs, objects, data structures, etc. that perform particular tasks. As used herein, by way of example and not by way of limitation, a computing device can include servers, PDAs, PC tablets, cellular phones, laptops, desktops, etc.

Exemplary System

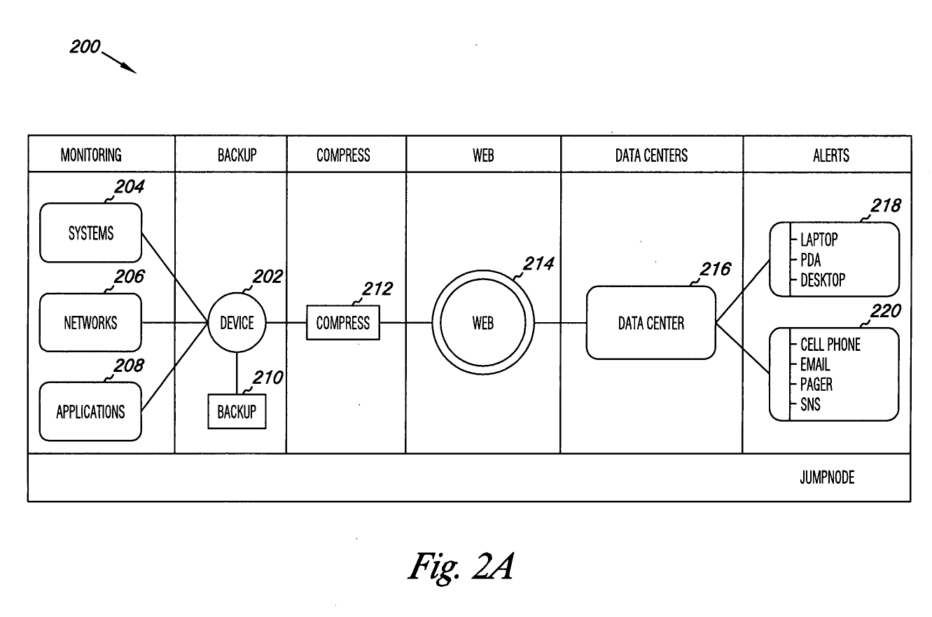

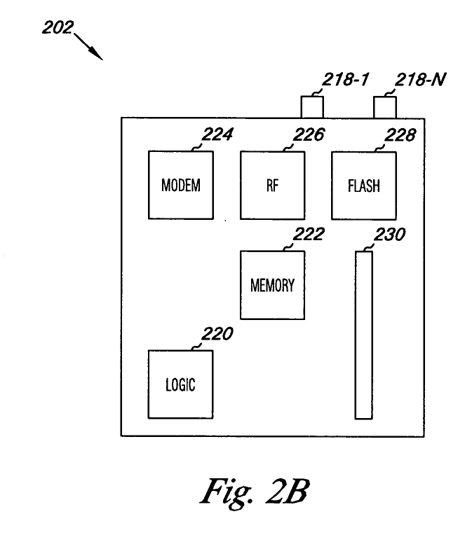

As noted above, embodiments of the present invention include systems, devices, and methods for system, network, and application monitoring. FIG. 2A is a block diagram of a system 200 embodiment including the above introduced internal monitoring device 202 connected to a company's systems 204, networks 206, and applications 208. As mentioned above the internal monitoring device includes logic and can be attached to a company's network via standard network connections. As will be described more in FIG. 2B, the internal monitoring device 202 can include internal memory to provide backup and storage, and can include one or more backup interfaces, illustrated at 210, to communicate and send and receive data. As shown in FIG. 2A, the internal monitoring device 202 can include logic and instructions for compression and encryption, illustrated at 212. For example, the logic can execute instructions to compress data using a known compression algorithms and can encrypt data using private key (asymmetric) and/or common key (symmetric) encryption techniques.

As shown in the embodiment of FIG. 2A, the internal monitoring device 202 can connect with one or more remote, third party data centers 216 in a stateless and connectionless manner. That is, the internal monitoring device 202 can connect with the one or more data centers 216 without the use of a secure transaction layer (e.g., without a private connection) by using web requests, e.g., stateless HTTP requests. The Internet, e.g., world wide web, is used as the transport layer for data transmission to the one or more data centers 216. A connection to the Internet can be made using one or more methods such as cellular, DSL, cable, and/or analog modem. Embodiments are not limited to these examples. And, as shown in the embodiment of FIG. 2A, the data centers 216 can issue alerts to fat 218 and thin 220 clients. As described in connection with FIG. 1, these fat 218 and thin 220 clients can include laptops, PDA, desktops, cell phones, email, pagers, SMS (short message service) devices, etc.

According to embodiments, the internal monitoring device 202 includes program instructions that execute to exchange data (e.g., information relating to systems within a network such as a server) with the one or more data centers 216 via temporary, stateless HTTP requests. That is, the connection is maintained between the internal monitoring device 202 and the one or more data centers 216 only for the immediate request, and then connection is closed without establishing a session which maintains state information. As the reader will appreciate, “virtual” in the context of networks refers to a virtual private network (VPN) which allows one network privileged access to another network, often remote. This requires setup work by parties of all participating networks. It also requires a user to authenticate themselves to establish a “session” on the remote network during which the user is granted access to the remote network's resources. This “session” maintains “state” information such as whether or not the user is authorized for access or if the session has exceeded idles time limits. Thus, network connections that establish sessions are stateful. Most modem applications maintain state, which means that they remember what was occurring the last time the program executed instructions, as well as configuration settings. By contrast, stateless implies having no information about what occurred previously. The temporary, stateless HTTP requests, or web requests, employed by the program instructions described herein are intrinsically stateless.

FIG. 2B illustrates an embodiment for the electrical components of the internal monitoring device 202. The internal monitoring device 202 is a diskless and fanless hardware solution and can be shipped and connected to a network at any company location. As shown in the embodiment of FIG. 2B, the device can include a number of connection ports 218-1, . . . , 218-N, of various types, e.g., USB (universal serial bus), RJ-11, etc., for forming a connection to a given company's network at any location or site. The internal monitoring device 202 includes logic 220 and memory 222. For example, the internal monitoring device 202 can be built around a RISC (reduced instruction set computing) processor with an ASIC (application specific integrated circuit) in order to perform its logic functions.

As shown in FIG. 2B, the internal monitoring device 202 includes a modem 224 and an RF transceiver 226 for cellular capabilities. In this manner, the internal monitoring device 202 can provide out-of-network, or out-of-band connectivity. For example, in the event that the internal monitoring device 202 is unable to connect with the one or more remote data centers 216 via a web request the internal monitoring device 202 can execute instructions to communicate with the one or more remote data centers 216 by telephone line via the built in modem 224. If telephone line service is also interrupted, communication can be established through the built in cellular capability of the RF transceiver 226. The internal monitoring device 202 includes a non-volatile memory 228 such as a NAND flash memory for storing instructions, including operating system instructions. In the unlikely event that all of the above mentioned communication methods fail, the internal monitoring device 202 will execute instructions to automatically store, e.g., in the NAND flash, all network information for later analysis once it regains connection to the one or more remote data centers 216.

According to various embodiments the operating system includes a Linux kernel which is designed for the application described herein. The Linux kernel, i.e., operating system, reduces the threat of worms and viruses. The internal monitoring device 202 can further include a serial card slot 230. Other electronic circuitry and components can further be included, as the same are known and understood in the art, to provide electrical connections between the components illustrated. Embodiments are not limited to the example components shown in FIG. 2B.

Exemplary Remote Data Centers/Multiple Company Offices

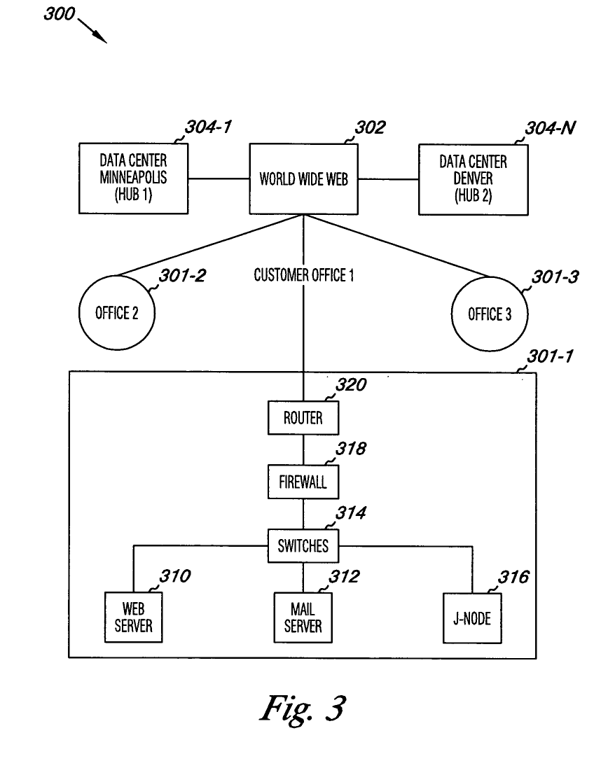

FIG. 3 illustrates a block diagram of a system 300 embodiment provided to a company having multiple company offices geographically removed from one another, e.g., Los Angeles, New York, and Boston. In FIG. 3 these are listed as Office 1 (labeled 301-1), Office 2 (labeled 301-2), and Office 3 (labeled 301-N). As one of ordinary skill in the art will appreciate upon reading this disclosure, any number of geographically separated offices can be monitored using the embodiments described herein and having an internal monitoring device 316 (labeled “J-node” in FIG. 3) shipped and connected to the company's network at each location.

In the embodiment of FIG. 3, the Office 1 (301-1) is shown in expanded detail to illustrate the interconnection of various network devices (such as described in FIG. 1) at this particular site. Thus, Office 1 (301-1) includes a web server 310 and a mail server 312 connected via network switches 314. In this embodiment, the internal monitoring device 316 is also illustrated connected to the office's network via switches 314. A router 320 is similarly illustrated in this diagram. As the reader will appreciate, routers such as router 320 can be connected to the network of a given office location both inside and outside of one or more firewall 318 protections provided to the network of the office.

According to the embodiments, the internal monitoring device 316 is connected to the location's network inside of the firewall 318 in order to provide internal monitoring tasks. As mentioned above, the internal monitoring device 316 embodiments are provided with program instructions, storable in flash memory, and executable by logic to perform various network monitoring functions internal to the particular LAN, e.g., 301-1. For example, program instructions may be provided to a NAND flash memory on the internal monitoring device 316 and executed by logic thereon to check and/or verify LAN security, VoIP (voice over IP) readiness and/or quality of service, quality of applications, etc. As the reader will appreciate, the instructions can execute according to SNMP (simple network management protocol) to get statistics such as disk usage, processor usage, memory allocation, etc. Likewise, the instructions can execute according to hypertext transport protocol (HTTP), file transfer protocol (FTP), transmission control protocol/internet protocol (TCP/IP), user datagram protocol (UDP), and internet control message protocol (ICMP), etc.

As shown in the embodiment of FIG. 3, the internal monitoring device 316, connected to a LAN at any business location or site, will connect with one or more data centers 304-1, . . . , 304-N, via the Internet using web requests, i.e. stateless HTTP requests, as described above. As the reader will appreciate, any number of remote data centers can be added to the system 300 embodiments described herein to afford unmatched redundancy over previous monitoring approaches. Companies using currently available monitoring products face significant risks if the product, or the computers on which the software product resides, fails. Previously, the only way to reduce that risk was to purchase multiple copies of the monitoring products each to be used on a computer attached to each of the separate networks. Previously, companies that purchase currently available software face the necessity of receiving updated versions that must be installed on their systems, either via software downloads or disks sent through the mail. To keep costs down, companies that sell monitoring software hold back on updates until a certain threshold number is reached-a risky policy for the customer.

The one or more data centers 304-1, . . . , 304-N include secure servers, e.g., high-powered enterprise class hardware. According to the embodiments, the servers are where the administration and configuration takes place. That is, all upgrades occur on the secure servers in the one or more data centers 304-1, . . . , 304-N ensuring that proprietary and company confidentiality is maintained. The software executing on these servers can be revised to optimize performance on a continuing basis without any action required by the company/customer who has installed one or more internal monitoring device 316 on their networks and/or systems.

Even more products, features, and services can be offered through the published website and downloaded to a given host, e.g., LAN to which a given internal monitoring device 316 is connected, using the same web request mechanism described earlier. The upgrades, additional products, features, and services will be provided to update the operating system in the flash memory of a given internal monitoring device 316. The internal monitoring device 316 thus get their instructions and updates from the one or more data centers 304-1, . . . , 304-N on what to monitor. Thus, a company using these embodiments will not need to purchase any additional hardware, train any staff, or configure any software and costly upgrades are avoided. According to various embodiments, program instructions on the system 300 execute to download and receive instructions and updates from the one or more data centers 304-1, . . . , 304-N only when instructions and/or updates are needed. That is, the program instructions can execute to verify if a most recent version is available on a given internal monitoring device and only transmit information and/or perform updates if something is needed or has changed. In this manner, bandwidth use is lessened.

According to the embodiments, the internal monitoring devices 316 offer plug-and-play simplicity. In other words, a company can sign up for initial service, or add services, via a published website, in a matter of minutes. The same day a completely configured internal monitoring device 316 (e.g., configured to the specifications/descriptions and type of monitoring requested, as given in the example above, for a particular company's network site) will be sent to the company. In some embodiments, a company can use the published website to self configure internal monitoring devices 316 to the specification/descriptions and type of monitoring desired bases on their known network and/or system needs. The company then simply plugs the internal monitoring device 316 into its network and monitoring can begin immediately. The internal monitoring device 316 can then begin sending information, e.g., data about the network, to the one or more data centers via web requests.

As the reader will appreciate upon reading this disclosure, the program embodiments described herein facilitate a method for network monitoring. Embodiments include making available a diskless and fanless internal monitoring hardware device 316 useable for internal network monitoring. As described, the device is connectable to a network, e.g., Office 1, without requiring any software reconfiguration to the network. The device 316 can exchange information with a data center 304-1, . . . , 304-N external to the network in a stateless manner. As the reader will appreciate, the purchase of the device can be facilitated via a website. A purchase can be made by any individual or entity including; a value added reseller (VAR), a purchaser internal to a company, a purchaser external to a company, a third party, etc. According to various embodiments, program instructions are executable via the website to download software tools to an individual and/or entity. The software tools include program instructions that can execute to probe the network for network items to monitor, and logically determine which network items should and should not be monitored. Using this information, the software tool can further execute instructions to configure the diskless and fanless internal monitoring hardware device 316 appropriately for internal network monitoring.

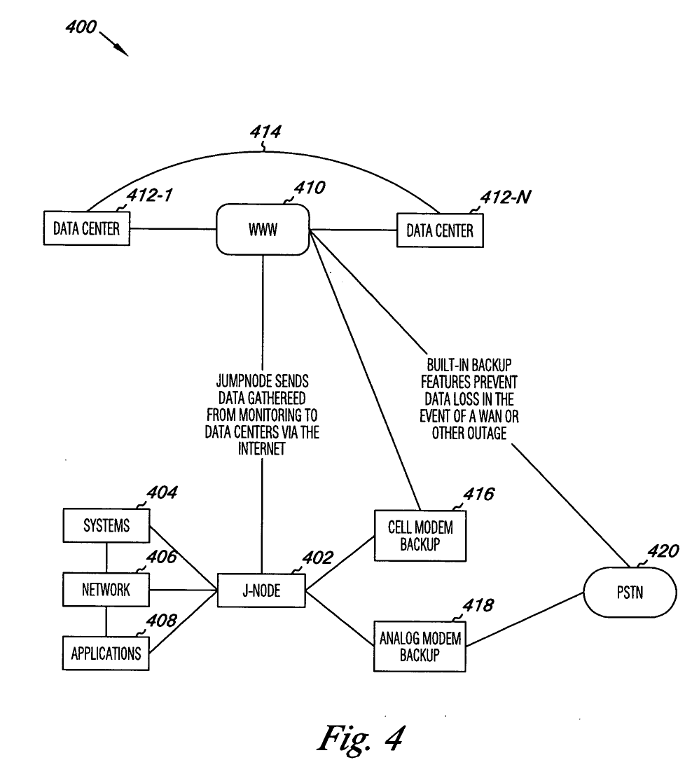

The internal monitoring device 316 does all the monitoring of the company's internal systems and networks (e.g., disk space on an Exchange Server). The internal monitoring devices 316 are powerful and focused on gathering information about the company's internal systems, networks, and applications. Program instructions on the internal monitoring device 316 execute such that upon attachment to a network, the internal monitoring device 316 will seek out all devices for potential monitoring. The internal monitoring device 316 will execute its program instructions to continually assess whether each designated computer, router, switch, etc., is functioning appropriately, e.g., how much capacity remains in each server and how much capacity (bandwidth) remains on the network. A given company may even add custom designed checks to the internal monitoring device 316. The internal monitoring device 316 will record all of this data and update the one or more data centers 304-1, . . . , 304-N on a periodic basis via the web requests or other backup interface (discussed in more detail in connection with FIG. 4).

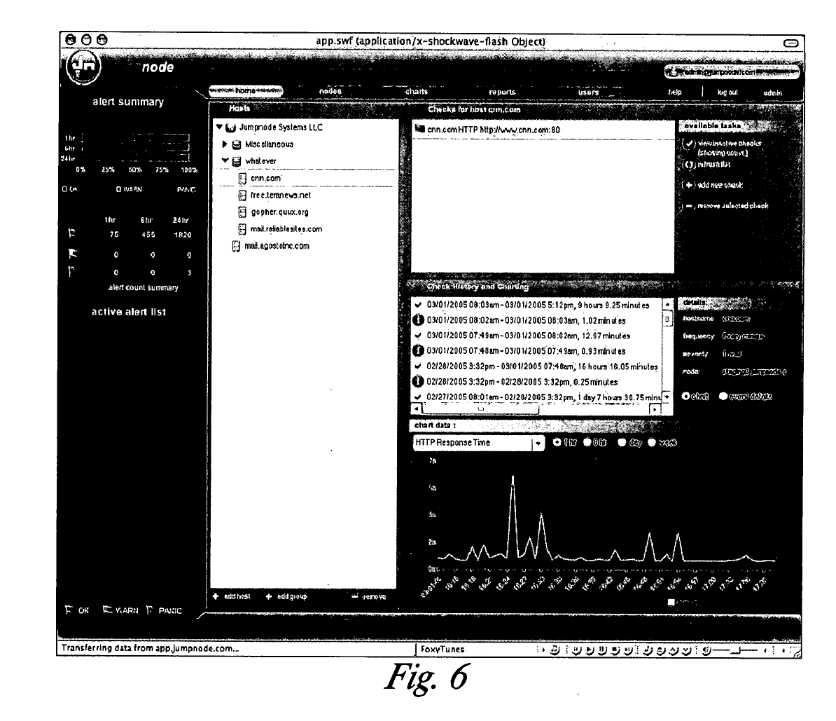

Program instructions executing on the secure servers of the one or more data centers 304-1, . . . , 304-N will compile all of this information into clear, intuitive reports, and graphs (discussed in more detail in connection with FIG. 6) that can be viewed in real time showing usage trends, network bottlenecks, etc. Screens showing the status of the network will be instantly available once the internal monitoring device 316 is connected to the network and begins sending data and/or alerts to the one or more data centers 304-1, . . . , 304-N.

According to various embodiments, each of the one or more data centers 304-1, . . . , 304-N provides redundant, secure storage of a company's data.

Therefore, in the unlikely event that one of the one or more data centers 304-1, . . . 304-N has a problem, another of the one or more data centers 304-1, . . . , 304-N will continue to provide uninterrupted service. As the reader will appreciate, the one or more data centers 304-1, . . . , 304-N can further provide a company with logging and offsite data storage.

To compliment the information supplied by the internal monitoring device 316, the one or more data centers 304-1, . . . , 304-N has the ability to monitor a company's network externally. As mentioned above, this form of “outside” monitoring will help isolate IT issues and will show whether an e-commerce site is functioning optimally, e.g., whether the audience for whom the site is intended, from varying locations, can access the site and use it.

For example, according to the embodiments an internal monitoring device 316 may be receiving network data “internal” to the LAN location 301-1 regarding the various network devices, e.g., web server, mail server 312, etc. The internal monitoring device can be reporting this information up to the one or more data centers 304-1, . . . , 304-N, through one interface or another (as discussed more in FIG. 4), reflecting that the network is up and functioning properly. However, without the present program embodiments executing through web requests to monitor the network location 301-1 from the “outside” in, i.e., external to LAN location 301-1, the company may be wholly unaware that its website is unavailable. Through the present combined embodiments, program instructions can execute on the one or more data centers 304-1, . . . ,304-N to periodically check the website and its performance, etc. Discovering that the website was down would help identify that the issue is not internal to LAN 301-1, but rather an issue with the connection from the external site to the LAN, e.g., a TI outage with the ISP or some other WAN issue.

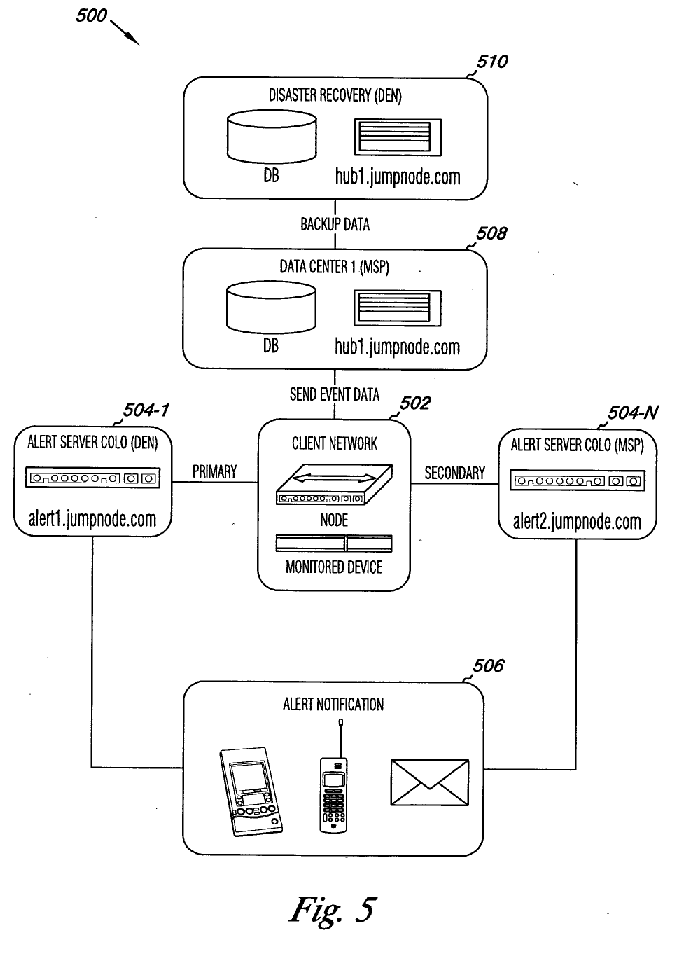

As the reader will appreciate, electronic nodes, e.g., servers located in different geographic regions or even nodes in a remote LAN designed to connect to a company's website from anywhere on the globe (e.g., alert servers 504-1, . . . , 504-N shown and discussed in FIG. 5), can be connected with the one or more data centers 304-1, . . . , 304-N to provide superior information as to the perspective of the audience for whom a particular application/service, website, etc. is intended. Program instructions executing on the one or more data centers 304-1, . . . , 304-N can compile and provide this information to a company, in the form of a “user's perspective score” reflecting what the intended audience really is experiencing.

As another example, a user of a given network, e.g., LAN 301-1, may be reporting difficulty with the network, e.g., email not functioning properly, etc. The company's IT (information technology) administration/administrator may actually be located in a different geographical location, e.g., office 2 (301-2). According to the embodiments, an authorized company user, e.g., network administrator, could access the one or more data centers 304-1, . . . , 304-N through the published website and actually request that the internal monitoring device 316 on network 301-1 attempt to send an email. This will then, very accurately, provide to the network administrator whether the mail server 312 at that location is truly experiencing problems, or whether it is more simply an issue of requesting the network user at location 301-1 to shut-down and reboot their machine.

Exemplary Redundancy to One or More Data Centers

FIG. 4 illustrates a block diagram of a system 400 embodiment showing the redundancy for communicating with one or more data centers. The embodiment of FIG. 4 again illustrates an internal monitoring device 402 (labeled here “J-node”) connected to a company's systems 404, networks 406, and applications 408. As described above in connection with FIGS. 2A-3, the internal monitoring device 402 is built with “out-of-band” connectivity to provide a unique store and forward capability.

In the embodiment of FIG. 4, the internal monitoring device 402 includes cell modem backup capabilities 416 and analog modem backup capabilities 418 to provide connectivity to the Internet 410 and the one or more data centers 412-1, . . . , 412-N. Primarily, the internal monitoring device 402 would communicate information collected on the company's systems 404, networks 406, and applications 408, to the one or more data centers 412-1, . . . , 412-N via the Internet using web requests, e.g., HTTP, as described above. However, if access to the Internet is interrupted, the internal monitoring device 402 will execute instructions to automatically communicate by telephone line 420, e.g., the PSTN (public switched telephone network), through a built in modem 418. This built-in backup prevents data loss in the event of a WAN or other outage.

As shown in FIG. 4, if telephone line service is also interrupted 420, the internal monitoring device 402 will execute instructions to maintain communication through a built in cellular device capability 416. Hence, the embodiments can maintain communication with no denial of service and no alert breakdown. In the unlikely event that all communication methods fail, the internal monitoring device 402 will execute instructions to automatically store all network information for later analysis once the internal monitoring device 402 regains connection to the one or more data centers 412-1, . . . , 412-N. As further illustrated in the embodiment of FIG. 4, the one or more data centers 412-1, . . . , 412-N may additionally be interconnected 414 with one another via a secure connection means, e.g., VPN (virtual private network), etc, to duplicate the data processed and stored on the one or more data centers 412-1, . . . , 412-N for safe archival in a geographically redundant, secure environment.

According to yet another embodiment, program instruction embodiments can be provided which execute to establish a secure transaction layer for an internal monitoring device to the one or more data centers 412-1, . . . , 412-N when all other communication methods fail. This embodiment can provide complimentary redundancy to the above described architecture. For example, in this embodiment, program instructions would execute to create a VPN tunnel only when issues cannot be resolved in the aforementioned manners. In this embodiment, program instructions can issue notifications (see FIG. 5) via email, for example, to provide an appropriate entity the methodology needed to proxy into the newly created temporary VPN to the company's network.

Exemplary Notification and Alerts

FIG. 5 is a block diagram of a system 500 embodiment illustrating notification escalation and alert capabilities. As mentioned above, the embodiments described herein execute instructions to maintain communication between the internal monitoring device attached to a company's/client's network 502 and one or more data centers 508 and 510 with no denial of service and no alert breakdown. In the example embodiment of FIG. 5, data center 510 represents a second backup, e.g., disaster recovery site, to data center 508. For example, data center 510 can maintain offsite backup data and hardware in the event of a physical catastrophe at the primary data center 508. As the reader will appreciate, any number of backup recovery sites can be included in the system embodiments described herein.

The internal monitoring device can execute program instructions to communicate with the one or more data centers 508 and 510 via web requests (i.e., a HTTP web transaction with an encrypted payload), analog modem, and/or cell modem. Thus, the embodiments use a stateless and connectionless method to communicate back to the one or more data centers 508 and 510 without requiring a constant transaction layer connection, e.g. VPN, or other special connectivity. This is a significant advantage over other approaches which need an encrypted communication channel and hardware and software changes to a company's network to facilitate such a communication channel.

Program instructions execute on the one or more data centers 508 and 510 to compile and analyze the information received from a company's/client's network 502. The program instruction embodiments execute to provide converged monitoring, unifying the data from external checks and internal checks. The program instructions execute to take the metrics from each of these types of checks and uses particular algorithms to ascertain what has failed and what the effect is on the company's business. The program instruction embodiments can then execute to issue warnings and alerts through emails, pagers, PDAs, cell phones, Blackberries, laptops, etc, shown at 506.

By way of illustration and not by way of limitation, an alert can be detected based on information gathered from a company's/client's network 502. In the embodiment of FIG. 5, a number of alert servers, 504-1, . . . , 504-N, are provided to the network. Any number of alert servers in remote geographic locations all over the globe can be included in the system embodiments described herein. Thus, FIG. 5 illustrates an alert server 504-1 colocated in Denver, Colo. and in Minneapolis, Minn. Alert server collocations allow for inexpensive redundancy for both network and hardware failures. The same hardware can also be used to perform external monitoring as mentioned in FIG. 3.

In the embodiment of FIG. 5 an internal monitoring device attached to a company's/client's network 502 executes program instructions to send out an alert notification to a first available alert server, e.g., primary alert server 504-1, directly via and alert data bus. According to embodiments, the program instructions execute to cycle through a storable, configurable list of available alert servers, e.g., 504-1, . . . , 504-N, until a connection is established with a ready and available alert server. The alert servers 504-1, . . . , 504-N include program instructions which execute to receive the alert from the internal monitoring device attached to a company's/client's network 502 and/or the one or more data centers 508 and 510. According to embodiments, program instruction embodiments on the alert servers 504-1, . . . , 504-N then execute to look up and cycle through a storable, configurable list of notification information, e.g., emails, pagers, PDAs, cell phones, Blackberries, laptops, etc, stored locally to send out alerts to.

The program instruction embodiments are executable to allow managers to establish schedules for various employees to share “on-call” responsibilities to ensure appropriate coverage and efficient management of employees' time. The program instruction embodiments execute to provide an escalation of the notification procedure up the chain of command in a company as needed. For example, the program instructions execute to ensure that if problems are not resolved within a specific selectably configurable period of time, notification will move up the company's chain of command. Hence, a failsafe procedure is established to ensure problem resolution even if someone along the chain of command drops the ball.

In the embodiment of FIG. 5, the program instructions on the alert servers 504-1, . . . , 504-N will execute to return an alert response to the internal monitoring device attached to a company's/client's network 502 indicating a success and/or failure notifying the intended alert recipient in the company's chain of command. The program instructions will additionally execute to identify who received the alert notification and by what means, e.g., emails, pagers, PDAs, cell phones, Blackberries, laptops, etc. The internal monitoring device attached to a company's/client's network 502 can then execute instructions to send such alert notification resolutions to the one or more data centers 508 and 510. As such, the notification and escalation procedures described herein provide a clear record of who is/was responsible for what event and what action was taken by whom. These embodiments thus allow alerting to occur even if the primary data center is down due to network or hardware issues. It also distributes the intensive load of alert processing to many machines.

Exemplary User Interface

FIG. 6 is a screen shot illustrating a user interface embodiment of system, network, and application monitoring. As mentioned, the embodiments described herein provide a unified view of a company's network, both from inside and outside the network firewall, without requiring any changes to the CPE (customer premise equipment), firewall rules, etc. The program instruction embodiments execute to monitor in real time the status of each system and network component indicated by a customer/client company. Information is displayed on a screen, such as illustrated in FIG. 6, that may be reformatted depending on the sophistication and information needs of the customer.

As shown in the embodiment of FIG. 6, all screen views are clear, uncluttered and intuitive, resulting in ease of use even for non-technical office managers. According to various embodiments, the screenshots, e.g., FIG. 6, use flash media to present information to a user. These attributes are highly attractive to companies with or without fulltime IT staff. According to various embodiments, program instructions execute to refresh the screenshots, e.g., FIG. 6, only when new information is received different from that displayed previously on a given screenshot. That is, the program instructions can execute to verify if the most recent information is being displayed and only refresh if new information is received or something on the company's network and/or system has changed.

The program instructions described herein execute to provide converged monitoring, unifying the data from external checks and internal checks. The program instructions can execute to take the metrics from each of these types of checks and uses particular algorithms to ascertain what has failed and what the effect is on the company's business. The effect on the business is built through the use of dependencies on how each monitored entity interrelates with one another. These dependencies are weighted to help the administrator and/or business person know what the effect is on their business. That is, program instruction embodiments can execute to quantify the severity level of a potential/actual failure or slowdown in a manner that greatly simplifies the network manager's job of sifting through information alerts to prioritize work and ensure immediate attention is given to the most severe problems.

A common problem with existing monitoring products is that they provide information in overwhelming amounts and in a confusing array. Instead of a barrage of streaming data, the program embodiments execute instructions to provide screens which are formatted to cleanly provide only the key data points that a company is interested in seeing. FIG. 6 illustrates how reports and graphs are provided in a clear and easy to understand manner, allowing a user to quickly see problem areas and trends for capacity planning.

For example, in a company with offices/stores/restaurants, etc., throughout the country, the network administrator can see on one screen the countrywide network, zoom in on a trouble spot and locate the source of the trouble. The administrator can also monitor on that same screen the functionality of the company's website, e.g., whether it is viewable, whether it has slow response times, etc. To achieve a comparable level of dependability, competitive offerings would require the establishment of complete monitoring tools in each separate office, which would still leave the administrator without a unified view of all offices on one screen. As mentioned above, previous approaches also leave the user at risk of failure along multiple points in the company's WAN.

As mentioned above, program instruction embodiments described herein will execute to offer trends and benchmarking metrics. Previously, an administrator would be unable to determine, for example, whether his/her network is more or less efficient that those of other comparable companies. Similarly, such individuals would have no manner of knowing whether a Windows-based system has better response time than a Linux-based system, etc. In contrast, according to the present embodiments, information gathered with a company's consent could be redacted to remove company sensitive information and shared on an anonymous basis to further leverage particular industry best practices. These metrics and underlying data will be valuable to both network administrators and market analysts.

Program instructions described in the above architecture can be leveraged to provide a number of products and services such as logging, storage, virus protection, content filtering, etc. Each of these areas alone is a significant market in itself and many companies have been built around products directed at just one of them. All of these needs, collectively, can be met through the above described embodiments without the introduction of any additional hardware or software on the customer's network other that the straightforward connection of the internal monitoring device thereto.

Remote Access

The present disclosure includes various system and method embodiments for remote access to private networks. Various embodiments can provide for remote access to a first device, e.g., a host/target device such as a mail server, web server, router, etc., located within a private network from a second computing device, e.g., a remote computing device, outside of the private network. As described below, in various embodiments, an internal node which can include hardware and software, e.g., computer executable instructions stored on a computer readable medium and executable by a processor to perform actions described herein, is located within a private network. In various embodiments, the internal node includes an internal monitoring device, e.g., J-Node 316 as shown in FIG. 3 and described earlier herein. In various embodiments, the internal node establishes an encrypted connection from inside the private network through a network firewall to a connection manager outside of the firewall. In some embodiments, the encrypted connection is a secure tunnel such as an SSH tunnel. In some embodiments, the secure connection is a VPN tunnel between the connection manager and the internal node. In various embodiments, a temporary remote access communication session between the remote computing device and a host computing device of a private network can be established such that the anonymity of the host computing device is maintained, e.g., a user of a client program of the remote computing device remains unaware of the IP address of the host device.

In various embodiments, an authorized user of a company or organization, e.g., a network administrator, can access a remote access hub, e.g., a remote data center as described earlier herein, and can set up a future remote access communication session for a remote computing device. As one example, a network administrator can set up access to a particular host device of the organization by a third party, e.g., an outsourced IT technician, for a particular time window in the future. For instance, the administrator can set up access for a time window of a few hours. In some embodiments, the IT technician can gain access to the particular host device for a limited time within the particular time window. For example, the administrator may set up access for a time window of three hours, within which the remote technician has an access time of up to one hour to a complete a maintenance task. In various embodiments, an audit log of the communications, e.g., commands, sent by and/or performed on the host computing device can be recorded. In this manner, a network administrator can review operations performed by the remote technician during the remote access communication session.

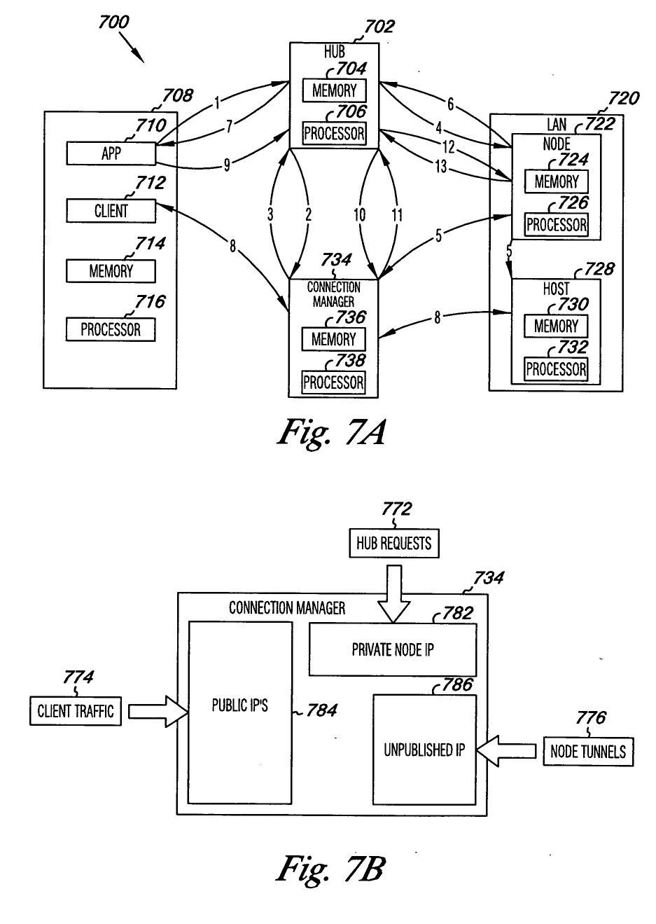

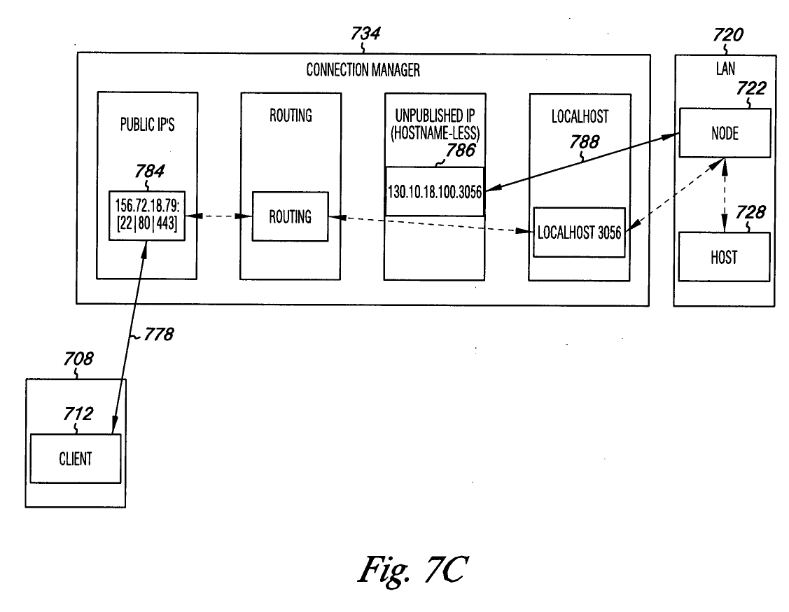

FIG. 7A illustrates a path diagram for a remote access communication session according to an embodiment of the present disclosure. The embodiment illustrated in FIG. 7A shows a system 700 that includes a remote access hub 702, e.g., a secure server or a data center 304-1 as described in connection with FIG. 3. As shown in FIG. 7A, the access hub 702 can include a memory 704 and a processor 706 and is located outside of a private network 720. Computer executable instructions can reside on the memory 704 and can be executed by the processor 706 to perform various actions described herein. As described in detail below, the access hub 702 can be used to instruct/direct the creation and teardown of secure connections associated with remote access communication sessions as described herein.

In various embodiments, the access hub 702 can broker communications between a number of computing devices, e.g., second computing device 708, remote to a private network 720, a number of private networks, e.g., 720, and a number of connection managers; e.g., 734. The access hub 702 includes executable instructions, e.g., program instructions, storable in the memory 704 and executable by processor 706 to load a user interface, e.g., a Dashboard web application or other user interface. In the embodiment illustrated in FIG. 7A, the access hub 702 facilitates remote access as described below. That is, access hub 702 brokers communications between a remote computing device 708 including a client program 712 as described in greater detail herein, a connection manager 734, and a private network, e.g., LAN 720, of system 700.

In the embodiment illustrated in FIG. 7A, the remote computing device 708 is remote to a private network, e.g., LAN 720. Remote computing device 708 includes a memory 714 and a processor 716. The remote computing device 708 can access an application 710, e.g., computer executable instructions that can be executed to request access to private network 720 and/or a first computing device thereof, e.g., host computing device 728 and/or various other devices (not shown) within the private network 720, e.g., LAN. The application 710 can be provided to and/or obtained from the access hub 702, e.g., via a download over the Internet using a web browser when the remote device is given access, e.g., IP address information for the access hub 702. As one of ordinary skill in the art will appreciate, access to the hub 702 may be limited to certain users and/or devices 708 by use of login information, e.g., usernames, passwords, etc. In various embodiments, the application 710 provides a list of private networks, e.g., LAN 720, and/or devices therein with which remote computing device 708 can establish a communication session, e.g., gain remote access. The list of private networks to which the remote computing device 708 can connect can vary depending on an access right of a particular device or user. In various embodiments, the remote computing device 708 includes a client program 712, e.g., a web browser, a SSH client, a telnet client, a Java applet, etc., used to communicate with a first computing device, e.g., host device 728 within the private network 720, once a communication session between the remote computing device 708 and the host computing device 728 is established as described below.

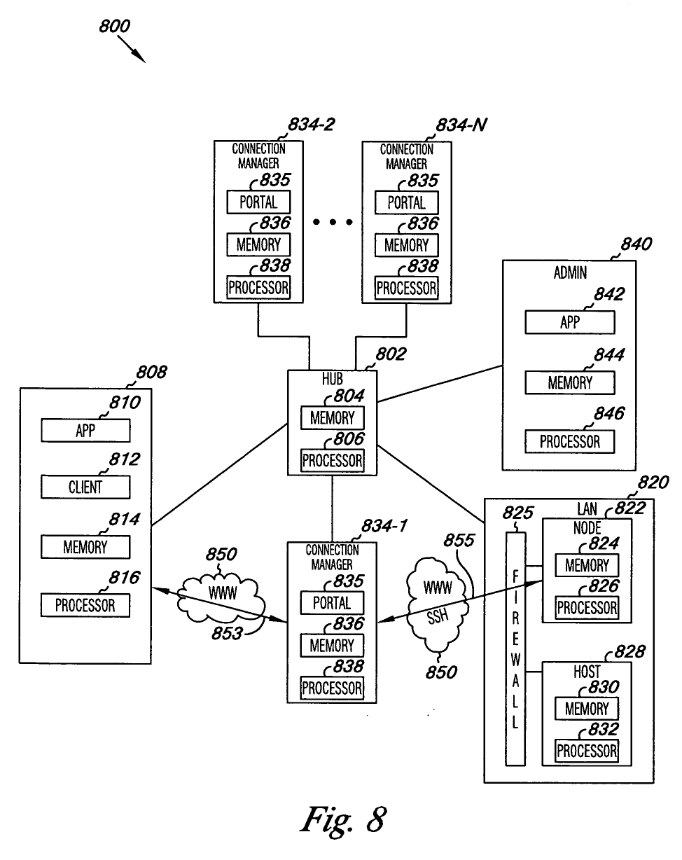

In the embodiment illustrated in FIG. 7A, the private network 720 includes an internal node 722 including a memory 724 and a processor 726. In some cases, the internal node 722 can include an ASIC, e.g., J-node 316 of FIG. 3. The internal node 722 is located inside a firewall (as shown in FIG. 8, for example) of private network 720 and can be connected to various computing devices, e.g., web server 310 and/or mail server 312 as shown in FIG. 3 and/or host device 728 as shown in FIG. 7A, within the private network 720. In the embodiment of FIG. 7, the internal node 722 is connected to a host device 728 that includes a memory 730 and a processor 732. In various embodiments, the functionality of an internal node, e.g., node 722, can be provided as computer executable instructions, e.g., a software agent. In such embodiments, the computer executable instructions can be stored on a memory of a device within private network 720 such as host computing device 728 or another computing device of network 720. In some embodiments, the internal node 722 can be a diskless and fanless hardware device such as that described in FIGS. 2-4. In such embodiments, the internal node can be used to facilitate network monitoring and remote access as described herein.

In various embodiments, computer executable instructions, storable in the memory 730, are executed by the processor 732 of the internal node 722 to establish an encrypted connection, e.g., a SSH (secure shell) tunnel, through a firewall of the network 722 to a connection manager 734, e.g., a proxy server, when instructed to do so by access hub 702. That is, when an access request is sent from the remote computing device 708 to access hub 702 and authorization confirmed, e.g., via login and password by executable instructions associated with the access hub 702. The connection manager 734 can be a publicly accessible server and can host a number of concurrent secure remote access communication sessions. The connection manager 734 can include processor 738 and memory resources 736 with executable instructions stored thereon to perform actions described herein. As described in further detail in connection with FIGS. 7B and 7C, computer executable instructions storable on memory 736 can be executed by processor 738 to forward communications from a remote computing device 708 to the internal node 722 once an encrypted connection 788, as shown in FIG. 7C, has been established between the connection manager 734 and the internal node 722.

As illustrated in the embodiment shown in FIG. 7A, an application 710, including computer executable instructions, can be provided to remote computing device 708, storable in memory 714, and executed by processor 716 thereon to perform embodiments herein for requesting access to a private network 720 from the access hub 702. The computer executable instructions of the application 710 can be retrieved from memory 714 and executed by the processor 716 to send a request (1) for access to a host device 728 within a private network 720 from a remote computing device, e.g., remote computing device 708. For example, by executing the computer executable instructions of application 710, a user of remote computing device 708 can log into an access hub 702.

As the reader will appreciate, based on the user's access rights and/or privileges, the computer executable instructions and data associated with application 710 can be loaded to memory from the access hub 702. The data, e.g., information, can include information on a number of private networks, e.g., LAN 720, from which the remote computing device can select to establish a remote access communication session with.

In various embodiments, the access request (1) is processed by computer executable instructions executing on the access hub 702. Processing the access request (1) can include executing instructions to send a configure forwarding request (2) to connection manager 734. Based on the configure forwarding request (2), the connection manager 734 can execute instructions in preparation for routing communications between the remote computing device 708 requesting remote access and an appropriate private network, e.g., private network 720 having a host/target device 728 to which the remote computing device 708 has requested access. The connection manager 734 can execute instructions to send a response (3) to the access hub 702 which can indicate whether connection manager 734 is available and/or prepared to route communications when the remote access communication session is established.

In various embodiments, once executable instructions associated with connection manager 734 have successfully been executed to configure forwarding and to communicate the same to the access hub 702, the access hub then executes instructions to send a request (4) to the internal node 722 instructing internal node 722 to establish a secure connection, e.g., an encrypted connection such as a SSH tunnel, to the connection manager 734 from inside the private network 720 through the firewall of private network 720. In some embodiments, instructions on the internal node 722 can be executed to make web requests such that the internal node 722 and access hub 702 communicate in a stateless fashion as described above. For example, the internal node 722 may periodically check with the access hub 702 to see if the hub 702 currently has any communications, e.g., requests that the internal node establish an encrypted connection to a connection manager, for the internal node 722.

In response to the request (4), the internal node 722 can direct the execution of instructions to establish an encrypted connection (5), e.g., open a secure tunnel, to the connection manager 734. One of ordinary skill in the art will appreciate upon reading this disclosure, the manner in which computer executable instructions can be executed in association with an internal node 722 to establish a secure connection, e.g., a SSH tunnel, to the connection manager 734 from inside the private network 720 through the firewall of private network 720. The internal node 722 can then direct the execution of instructions to send an acknowledge message (6) to the access hub 702 informing the hub that the encrypted connection, e.g., SSH tunnel, is established. In the embodiment shown in FIG. 7A, the access hub 702 can execute instructions to send a message (7) to the remote computing device 708 informing the remote computing device 708 of the IP address for connection manager 734. The message (7), in effect, indicates that the encrypted connection is established between the connection manager 734 and the host/target device 728. In various embodiments, the anonymity of the host/target device 728 is maintained, e.g., the IP address of the host/target device 728 does not have to be known or disclosed to the remote computing device 708. The message (7) can include access information that can be used by the client program 712 on the remote computing device 708 to establish the remote access communication session with the private network 720 and the host/target device 728. The access information sent from the access hub 702 to the remote computing device 708 can include a particular public IP address and port of the connection manager 734 that can be used by client program 712 to connect to connection manager 734.

In various embodiments, connecting to the connection manager 734 using the access information, e.g., the particular public IP address and port of the connection manager 734, establishes a remote access communication session between remote computing device 708 and host/target computing device 728. During a remote access communication session, communications (8) between the remote computing device 708 and the connection manager 734 are exchanged through the connection manager 734 to the host/target computing device 728 via the encrypted connection (5), e.g., SSH tunnel or other encrypted connection. In such embodiments, instructions can be executed by the internal node 722 to forward communications (8), forwarded to the internal node 722 from the connection manager 734, to the host/target computing device 728 via the encrypted connection (5).

According to embodiments, the encrypted connection (5) between the connection manager 734 and the host/target device 728 has been facilitated by the internal node 722. In various embodiments of the present disclosure, the encrypted connection is only established, e.g., opened, when access is requested by a remote computing device 708 and the access request is approved by the access hub 702. That is, the internal node 722 does not constantly have a port open, e.g., “listening,” for web requests. In this manner, such embodiments are less susceptible to security breaches than prior remote access solutions that constantly expose a private network to Internet connections via inbound web requests, e.g., SSL web requests on port 443 for example.

As described herein, in various embodiments, the communication session is an anonymous communication session. That is, the remote computing device 708 remains unaware of the location, e.g., IP address, of the host/target computing device 728. Maintaining the anonymity of the host/target computing device 728 can provide various benefits related to privacy and security. For example, an organization may wish to allow a third party IT technician to remotely access a private network, e.g., LAN 720, of the organization in order to perform a maintenance task on the network or a computing device thereof. In such circumstances, the organization may not want the remote third party to know the IP address and/or physical location of the private network being accessed.

According to various embodiments, and as described further in connection with FIGS. 8-11, a remote access communication session between a remote computing device, e.g., remote computing device 708, and a host/target device, e.g., host device 728, can be terminated in various manners. In the embodiment illustrated in FIG. 7A, the remote computing device 708 executes instructions associated with application 710 to send a session termination message (9) to the access hub 702 which indicates that the remote communication session can be terminated, and that the encrypted connection between connection manager 734 and the internal node 722, e.g., the SSH tunnel, can be closed.

In this embodiment, the access hub 702 executes instructions to send a message (10) to connection manager 734 for the connection manager 734 to teardown the connection between the client program 712 and connection manager 734, e.g., connection 778 shown in FIG. 7C. The connection manager 734 then executes instructions to send a response (11) to indicate whether the connection was closed successfully. In this embodiment, the access hub 702 also executes instructions to send a message (12) to the internal node 722 to inform the internal node 722 to close the encrypted connection, e.g., encrypted connection 788 shown in FIG. 7C, between the internal node 722 and the connection manager 734. The internal node 722 then executes instructions to send a response (13) to the access hub 702 which indicates whether the encrypted connection, e.g., encrypted connection 788 shown in FIG. 7C, has been torn down, e.g., closed, successfully.

As described further below, various embodiments of the present disclosure allow for publicly available temporary secure remote access to a private network 720 using a publicly accessible connection manager 734 and an internal node 722 within the private network 720 that is capable of sending outbound requests to the connection manager 734 to establish an encrypted connection between the internal node 722 and the connection manager 734 from inside the private network 720 through a firewall of the private network.

FIGS. 7B and 7C illustrate address mapping and communication forwarding according to an embodiment of the present disclosure. As one of ordinary skill the art will understand, the embodiments can be performed by software, application modules, and computer executable instructions operable on the systems and devices shown herein or otherwise. Embodiments of the present disclosure, however, are not limited to any particular operating environment or to software written in a particular programming language. Software, application modules and/or computer executable instructions, suitable for carrying out embodiments of the present invention, can be resident in one or more devices or locations or in several and even many locations.

Unless explicitly stated, the method embodiments described herein are not constrained to a particular order or sequence. Additionally, some of the described method embodiments can occur or be performed at the same point in time.

As shown in the embodiment illustrated in FIG. 7B, the connection manager 734 can include a number of associated public IP addresses 784, e.g., residing on an encrypted domain name server (DNS). The connection manager 734 will also include an unpublished IP address 786, and a private IP address 782. In various embodiments, the connection manager 734 is publicly accessible via public IP addresses 784. Communications (8) as shown in FIG. 7A, e.g., data traffic such as client program traffic 774 from client program 712 shown in FIG. 7A, can be sent from a remote device, e.g., remote computing device 708, to the connection manger 734 using an available public IP address selected from the group of public IP addresses 784. In various embodiments, a particular public IP address 784 can be associated with a particular remote access communication session, and the connection manager 734 can host a number of concurrent remote access communication sessions using a number of different IP addresses from the group of available public IP addresses 784. As one of ordinary skill in the art will appreciate, Dynamic Host Configuration Protocol (DHCP) or other suitable protocols may be used to allocate the IP addresses associated with the remote access communication sessions.

The embodiment of FIG. 7B illustrates requests 772, e.g., requests (2) and

(10), shown in FIG. 7A, from an access hub, e.g., hub 702 shown in FIG. 7A, being sent to the connection manager 734 using a private IP address 782 associated with the internal node 722, e.g., request 772 can include a request to configure forwarding request (2) as shown in FIG. 7A. In various embodiments, data traffic 776 from internal node 722 is sent to the connection manager 734 via unpublished IP address 786, e.g., via encrypted connection (5) in FIG. 7A. The unpublished IP address 786 is used by the internal node 722 to open an encrypted connection from the internal node 722 to the connection manager 734 through a firewall of a private network 720 from within the private network 720.

FIG. 7C illustrates an embodiment of communication forwarding and address mapping for a remote access communication session according to the present disclosure. The embodiment illustrated in FIG. 7C shows a direct connection 778 from a client program 712 to connection manager 734 via a public IP address 784 of connection manager 734. As the reader will appreciate, the port number used by the client program 712 depends on the type of client program and/or protocol. For instance, port 80 on the connection manager 734 can be used for HTTP communications, port 22 on the connection manager 734 can be used for SSH communications, etc. In various embodiments, the data traffic from the client program 712 to connection manager 734 can be encrypted or unencrypted. Embodiments are not limited to a particular client program 712 and/or protocol.

The embodiment illustrated in FIG. 7C also shows an established secure connection 788, e.g., an encrypted connection such as an SSH tunnel. As shown in this embodiment, the encrypted connection 788 is from the internal node 722 of private network 720 to an unpublished IP address 786 of connection manager 734. In various embodiments and as described herein, the connection 778 and encrypted connection 788 can be used by a remote computing device 708 to remotely access a host device 728 of private network 720 in a secure manner. In various embodiments, program instructions can be executed by the connection manager 734 to encrypt unencrypted data traffic, e.g., HTTP traffic, received from the client program 712. As one of ordinary skill in the art will appreciate, communications, e.g., data traffic, can be forwarded through the connection manager 734 to the internal node 722. Program instructions can be executed by the internal node 722 to forward the communications to the host computing device 728.

FIG. 8 illustrates a system for remote access according to an embodiment of the present disclosure. The system illustrated in the embodiment of FIG. 8 includes a remote access hub 802 in communication with a remote computing device 808, a number of connection managers 834-1, 834-2, . . . 834-N, a private network 820, and a network administrator device 840.

In the embodiment illustrated in FIG. 8, the access hub 802 includes a memory 804 and a processor 806. The access hub 802 can be used to set up and teardown remote access communication sessions between a remote computing device 808 and one or more private networks 820 and/or devices therein, e.g., host computing device 828. In various embodiments, requests for remote access communication sessions can be received by access hub 802 from remote computing device 808 and processed by the access hub 802. For instance, a user of remote computing device 808 can load an application 810, e.g., a web page or other user interface, from access hub 802. In various embodiments, access to the access hub 802 can be restricted based on a login, a password, and/or other security feature used to authenticate a user. The application 810 can provide the user of computing device 808 with a menu having a number of private networks to which the remote computing device 808 can request access. The particular networks to which the user of remote computing device 808 can request access can depend on access rights associated with a particular user. In various embodiments, the application 810 does not provide information, such as a physical location and/or IP address of the particular networks and/or devices thereof, that remote computing device 808 may gain access to.

In various embodiments of the present disclosure, program instructions are storable on a memory 804 and executable by a processor 806 of access hub 802 to broker communications between various system components, e.g., remote computing device 808, connection managers 834-1 to 834-N, internal node 822, and administrator computing device 840, among other system components. For example, based on a remote access request from remote computing device 808, the access hub 802 can request a connection manager, e.g., connection manager 834-1, to configure forwarding, e.g., to prepare for a connection from remote computing device 808. Such preparation can include program instructions storable on memory 836 being executed by processor 838 to determine a particular public IP address and port number to be used to receive communications from a client program 812 on the remote computing device 808 to the connection manager 834-1. Program instructions can also be executed to determine a particular unpublished IP address and port number of connection manager 834-1 to be used in establishing an encrypted connection, e.g., SSH tunnel 855, between internal node 822 and connection manager 834-1. Example embodiments of these actions have been described in connection with FIGS. 7A-7C.

In various embodiments, the system 800 can include a number of connection managers 834-1, 834-2, . . . 834-N that may be geographically separated. In such embodiments, program instructions storable on access hub 802 can be executed to determine an appropriate connection manager, e.g., 834-1, from the number of available connection managers, 834-1, 834-2, . . . 834-N, to which the remote computing device 808 can connect to establish a remote access session with host device 828. An appropriate connection manager, e.g., 834-1 can be determined in a variety of manners. For example, an appropriate connection manager can be selected based on geographic location. For instance, the access hub 802 can include logic to determine a geographic location of remote computing device 808 and/or internal node 822 based on IP addresses of the devices. In such cases, an appropriate connection manager, e.g., 834-1, can be selected based on which is physically located closest to the remote computing device 808 and the internal node 822. An appropriate connection manager 834-1 can also be determined based on a preference of a particular user of remote computing device 808. For example, a user can set a preference such that program instructions are executed by the access hub 802 to use a particular connection manager each time the particular user requests a remote access session. An appropriate connection manager can also be determined by the access hub 802 based on a traffic level, e.g., how many remote sessions each connection manager is servicing, etc. The access hub 802 can also determine an appropriate connection manager, 834-1, 834-2, . . . 834-N based on round trip “ping” time from each available connection manager to the requesting remote computing device 808 and internal node 822 of the private network 820 being accessed. Embodiments are not limited to these examples.

Based on a remote access request from remote computing device 808, program instructions can also be executed by the access hub 802 to inform the internal node 822 to open an encrypted connection, e.g., an encrypted connection (5) of FIG. 7A, an SSH tunnel 855 as shown in FIG. 8, or other encrypted connection, from the internal node 822 to the connection manager 834-1 through a firewall 825 using a particular unpublished IP address and port number of the connection manager 834-1 as described in connection with FIGS. 7B and 7C. The encrypted connection 855 to the connection manager 834-1 can be opened over a suitable information space, e.g., WWW (World Wide Web) 850 as shown.

In various embodiments, program instructions storable on a memory 824, e.g., a NAND Flash memory, can be executed by processor 826 of internal node 822 to open the encrypted connection, e.g., SSH tunnel 855, to the connection manager 834-1 through the firewall 825 from within the private network 820. As described herein, in various embodiments, the encrypted connection 855 is established via outbound only requests to the connection manager 834-1 and communications from an access hub, e.g., access hub 802. In this manner, the encrypted connection 855 is only opened, and access to within private network 820 is only gained, temporarily. That is, internal node 822 does not constantly have a port, e.g., port 443, “listening” for inbound web requests.

In various embodiments, program instructions can be executed by the internal node 822 to inform the access hub 802 that the encrypted connection 855 was successfully established. The access hub 802 can then inform the requesting remote device 808 that the encrypted connection 855 is open and can provide the remote device 808 with access information that can be used by the remote device 808, to connect to a connection manager, e.g., connection manager 834-1, in order to establish a remote access communication session with a host computing device 828 of the private network 820. In various embodiments, and as discussed above, the access information can include a public IP address and port number which the remote device 808 can use to establish a connection 853 to the connection manager 834-1. Once connected to the connection manager 834-1, the computing device 808 can communicate with host computing device 828 during the remote access communication session via a client program 812, e.g., a web browser, SSH client, or other client. In various embodiments, communications, e.g., data traffic and/or commands, are sent via the client program 812 to the connection manager 834-1 and forwarded through the encrypted connection 855 and the internal node 822 to the host computing device 828 as discussed in connection with FIGS. 7B and 7C. The encrypted connection 855 can be established over a suitable information space, e.g., WWW 850 as shown.

In various embodiments of the present disclosure, and as shown in FIG. 8, the connection managers 834-1, 834-2, . . . 834-N can host a portal 835, e.g., an encrypted web portal. In such embodiments, the hosted web portal 835 can be accessed using an associated URL. In such embodiments, the access information provided from the access hub 802 to the remote computing device 808 can include an IP address of the connection manager, e.g., 834-1 and the URL associated with the web portal 835. The web portal 835 can support a number of web based applications using a number of protocols, e.g., SSH, TELNET, FTP (file transfer protocol), and RDP (remote desktop protocol), among other protocols. In various embodiments, the web portal 835 can be accessed over a secure protocol such as SSL (secure sockets layer) or other secure protocol. In various embodiments, the web portal 835 hosted on connection manager, e.g., 834-1 allows for multiple remote computing devices, e.g., 808, to access a private network or networks, e.g., 820, via a single IP address. That is, in such embodiments, a single IP address for the connection manager 834-1 can be provided to multiple remote devices 808.

In various embodiments, program instructions are executed on the connection manager 834-1 to authenticate a user of remote computing device 808 prior to the user gaining access to the web portal 835. In various embodiments, the connection manager 834-1 can be in communication with a number of different private networks each having one or more internal node as the same have been described herein. Each internal node 822 can be connected to one or more components, e.g., servers or routers, among various other components, of a private network 820. In such embodiments, a user can gain secure remote access to a number of private networks using the web portal 835 hosted on a connection manager, e.g., 834-1. The web portal 835 can include a menu of private networks, e.g., private network 820, each of which may include an internal node, e.g., internal node 822, inside a firewall of the network 820, from which a user of a remote computing device 808 can select to establish a remote access communication session. The ability of embodiments of the present disclosure to provide access to a number of different private networks from a shared connection manager, e.g., connection manager 834-1, via a hosted web portal 835 can be beneficial because a user of a remote computing device, e.g., remote computing device 808, need not login to a number of different devices, e.g., a number of connection managers 834-1, 834-2, . . . 834-N, in order to gain access to different private networks 820 and/or devices therein, e.g., host device 828.

In various embodiments, an audit log of information associated with a remote access communication session can be generated. For example, program instructions can be executed by processor 838 of connection manager 834-1 to record various information including a start time of the communication session, e.g., the time at which a remote computing device 808 loads web portal 835, an end time of the communication session, a time duration of the communication session, and/or an IP address of the remote computing device 808.

The audit log can also include various information associated with a user of the remote computing device 808 during the communication session, e.g., a username, a password, identification number, etc. Also, since web portal 835 is hosted by the connection manager 834-1, data traffic, e.g., commands, keystrokes, mouse movements, etc., entered by a user of remote computing device 808 via the web portal 835 can be sent directly to the internal node 822 from connection manager 834-1 via encrypted connection 855. Therefore, program instructions can be executed on connection manager 834-1 to record the commands sent from the remote computing device 808 to the internal node 822 of private network 820. Program instructions can also be executed to decrypt the commands, store the commands in memory 838, and/or send the commands to remote access hub 802 to be stored thereon, e.g., on memory 804. The information contained in the audit log can be used by an organization for various reasons. For example, the audit log can allow an organization's network administrator to determine how long a particular remote computing device 808 had access to the organization's private network 820, which commands were sent to a particular host device 828 of the network, e.g., which tasks were and/or were not performed by the remote computing device 808, among other information. Such an audit log may be particularly beneficial to an organization when the user of the remote computing device 808 is an IT technician who may or may not be an employee of the organization. In such cases, the audit log can be used to monitor the activities of the remote technicians. For example, instructions can be executed on the access hub 802 to direct the termination of a remote access communication session when the audit log information indicates that the remote computing device 808 has exceeded an authorized scope of activity, e.g., has attempted an unauthorized access of another host device, has sent unauthorized commands to the host device 828, or has exceeded a range of tasks to be performed. Embodiments are not limited to these examples.

Also, in cases in which multiple remote devices such as remote computing device 808 may have access to a particular private network 820 and/or host device 828 therein, the audit log can allow the tracking of which commands were sent by each of the multiple remote computing devices, e.g., remote computing device 820, having remote access. That is, the commands sent by a remote computing device 820 to a host computing device 828, during a remote access communication session, can be monitored via the audit log.

In various embodiments of the present disclosure, the remote access communication session between the remote computing device 808 and the host computing device 828 is an anonymous communication session. That is, in various embodiments a user of remote computing device 808 remains unaware of an IP address of the host computing device 828 during the communication session such that the anonymity of the host computing device 828 to the remote computing device 808 is maintained. Maintaining the anonymity of a host device 828 and/or private network 820 can be beneficial to an organization that may want to allow remote access for remote computing devices, e.g., remote computing device 808, but may not want remote computing devices 808 to learn the location of the host 828 and/or private network 820 being accessed.

In various embodiments, the encrypted connection 855 between the internal node 822 and the connection manager is established, e.g., opened, for a predetermined amount of time, e.g., a 30 minute, a one hour, or a four hour time window. Embodiments are not so limited. In some embodiments, the remote access communication session between the remote computing device 808 and the host computing device 828 can be established for a particular time duration within the predetermined time window. In such embodiments, the particular time duration can be less than or equal to the predetermined time window. For example, an encrypted connection 855 may be opened for a four hour period within which the remote computing device 808 can establish a remote access communication session with the host computing device 828 for a one hour period. In this example, program instructions can be executed by the connection manager 834-1 and/or the access hub 802 to teardown the connection 853 and/or close the encrypted connection 855 after the four hour time window has expired or after the expiration of the one hour period allotted for the remote access communication session. As such, in various embodiments, the opening of the encrypted connection 855 and/or the establishment of the remote access communication session is temporary.

In embodiments in which the remote access communication session has a predetermined time duration, the communication session can be terminated prior to the expiration of the predetermined time window duration and/or prior to the expiration of the one hour period allotted for the remote access communication session. For example, a user of remote computing device 808, e.g., an IT technician, can terminate the session prior to the expiration of the predetermined time duration, e.g., by sending a session termination message to the access hub 802 before the allotted time limit, e.g., an hour or two hour time limit, has expired. For instance, the IT technician may finish performing a maintenance task ahead of schedule and can opt to terminate the remote access communication session in order to close the encrypted connection 855 to the private network 820 for security purposes. In some embodiments, program instructions can be executed to terminate the remote communication session, e.g., to close the encrypted connection 855, if a particular time duration has passed since a last communication sent by the remote computing device 808. That is, program instructions can be executed to end the communication session if the remote computing device has remained idle for more than a particular time, e.g., 5 minutes, 10 minutes, etc.

In some embodiments, program instructions can be executed to terminate a remote access communication session based on an unauthorized action by a remote computing device 808 and/or a user thereof. That is, the access hub 802 can execute instructions to direct the closing of the encrypted connection 855 prior to the expiration of the predetermined time duration for the communication session if an unauthorized action occurs. For example, the communication session can be terminated if an unauthorized command is sent from remote computing device 808 to host computing device 828. An unauthorized command can include exceeding an access right by attempting to access a host device 828 of private network 828 for which the user has not been granted access and/or attempting to perform an unauthorized maintenance task on the host device 828, among various other unauthorized commands. In embodiments in which an audit log is generated as described above, instructions can be executed by the access hub 802 to determine, from the audit log information, when an unauthorized command is sent from the remote computing device 808. In such embodiments, the access hub 802 can direct the termination of the remote access communication based on the audit log information.

As shown in FIG. 8, in some embodiments, a user, e.g., a network administrator, of administrator computing device 840 can load an application 842, e.g., a Dashboard user interface (UI) such as a web page, from access hub 802 in order to set up a remote access communication session for a user of a remote computing device, e.g., a remote IT technician using remote computing device 808. In such embodiments, the network administrator can provide various information to the access hub 802 via Dashboard 842. The information can include particular parameters associated with the remote access session setup. For instance, the network administrator can establish to which private network 820 and/or host computing device 828 therein the user of a remote computing device 808 is allowed access. The network administrator can also establish a particular port of the connection manager 834-1 and/or a particular application hosted by the connection manager 834-1 that the user of remote computing device 808 is to use to gain access. In various embodiments, the network administrator can also establish a particular date/time at which the user can gain remote access and/or a time duration of the access session, and/or a particular maintenance task to be performed. The information provided by the network administrator to the access hub 802 can also include an email address of a user of a remote computing device, e.g., 808, a username, and/or a password, among other information.

In various embodiments, program instructions can be executed by the access hub 802 to use the information/parameters provided by the network administrator 840 and to send an invitation to a user of remote computing device 808 to participate in the remote access communication session setup by the network administrator 840. For example, program instructions can be executed by the access hub 802 to send an email invitation to the user of remote computing device 808 by using the email address provided by the network administrator.

As an example, the email invitation received by the user of remote computing device 808 can provide the user with the various information and/or parameters established by the network administrator. For instance, the invitation can provide the user of remote computing device 808 with information associated with the remote access communication session such as a maintenance task to be performed on a particular host device, e.g., host computing device 828 of a particular private network, e.g., private network 820. The invitation can also provide the user of remote computing device 808 with the date/time the task is to be performed, the duration of the remote access communication session, and the particular port and/or hosted application, e.g., web portal 835, of the connection manager, e.g., 834-1, that the user of remote computing device 808 is to use to gain remote access.

In this example, a user of remote computing device 808 can accept the invitation by clicking on a URL of the access hub 802 provided in the email within the time/date window specified. Clicking on the URL within the time window can initiate the remote access communication session. That is, program instructions can be executed by the access hub 802 to send a request to the connection manager, e.g., 834-1, to prepare for a connection from the remote computing device 808 associated with a particular user. It is noted that the IP address of the remote computing device 808 can be obtained by the user of the remote computing device 808 clicking on the URL provided in the email invitation. In some embodiments, program instructions can be executed to send the IP address of the remote computing device 808 to the access hub 802 when the user of remote computing device 808 opens the email. As discussed previously, program instructions can also be executed by the access hub 802 to inform the user of remote computing device 808 which connection manager, e.g., 834-1, to connect to. The user of remote computing device 808 can then gain access to the particular private network 820 and/or host device therein, e.g., host device 828, for the particular time duration.

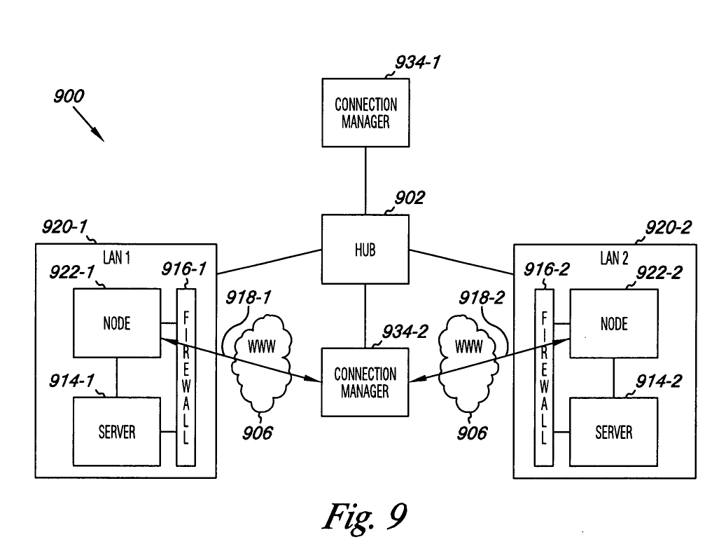

FIG. 9 illustrates another system 900 for remote access according to an embodiment of the present disclosure. The system illustrated in the embodiment of FIG. 9 includes a remote access hub 902 in communication with a first private network 920-1 (shown as LAN 1), a second private network 920-2 (shown as LAN2), a first connection manager 934-1, and a second connection manager 934-2. Embodiments are not so limited, e.g., system 900 can include more or fewer than two private networks and/or two connection managers.

In the embodiment illustrated in FIG. 9, the first and second private networks 920-1 and 920-2 each include a respective internal node 922-1 and 922-2, e.g., internal node 722 of FIG. 7A, internal node 822 of FIG. 8, or J-Node 316 of FIG. 3. The internal nodes 922-1 and 922-2 can facilitate remote access as described herein. The internal nodes 922-1 and 922-2 are within the respective private networks 920-1 and 920-2 and behind respective firewalls 916-1 and 916-2. The internal nodes 922-1 and 922-2 are connected to respective computing devices 914-1 and 914-2. The computing devices 914-1 and 914-2 can be servers (as shown) or other computing devices, e.g., various computing devices as described in FIG. 1.

The system 900 illustrated in FIG. 9 can be used to establish a secure remote access communication session between computing devices, e.g., computing devices 914-1 and 914-2, in separate private networks, e.g., 920-1 and 920-2. Communications, e.g., data traffic, between the computing devices 920-1 and 920-2 during the established remote access communication session can be brokered through a connection manager, e.g., connection manager 934-2 as shown in FIG. 9, and the internal nodes 922-1 and 922-2. Security during the established remote access communication session is provided by encrypted connections 918-1 and 918-2, e.g., SSH tunnels. In this embodiment, the encrypted connections 918-1 and 918-2 are established by the internal nodes 922-1 and 922-2 tunneling to a particular port using an unpublished IP address of the connection manager 934-2 provided by access hub 902. Tunneling from within the private networks 920-1 and 920-2 using the internal nodes 922-1 and 922-2, which are trusted nodes of respective networks 920-1 and 920-2, can provide security benefits, among other benefits.

The embodiment illustrated in FIG. 9 provides a manner in which remote private networks, e.g., LAN 1 and LAN 2, which may be LANs of separate organizations, can remotely access each other in a temporary, anonymous, and secure fashion. As an example, a first company having a first network 920-1 may request remote access to a second company's private network 920-2. That is, the first company may request to establish a connection from internal node 922-1 to internal node 922-2 such that a remote access communication session can be established in which computing device 914-1 can communicate with computing device 914-2. In this example, computing device 914-1 can act as a remote computing device, e.g., remote computing device 708 and/or 808 as described in FIGS. 7A and 8. Also, in this example, computing device 914-2 can act as a host/target computing device, e.g., host computing device 728 and/or 828 as described in FIGS. 7A and 8. As discussed above in connection with FIGS. 7A, 7B, 7C, and 8, communications received from remote computing device 914-1 by an internal node 922-2 within host network 920-2, during a remote access communication session according to embodiments of the present disclosure, are forwarded to the appropriate host computing device, e.g., server 914-2 in this example. In this manner, a remote computing device 914-1 of a first company can remotely access a host computing device 914-2 of a second company securely, anonymously, and temporarily.

Establishment of a remote access communication session according to the embodiment illustrated in FIG. 9 is similar to that described above in connection with FIGS. 7A and 8. For example, as discussed in connection with FIG. 8, a network administrator or other provider external to private networks 920-1 and 920-2 can access an access hub 902 to setup a remote access from network 920-1 to 920-2 via a Dashboard web application or other user interface. The setup can include establishing various access rights, e.g., usernames and/or passwords to be used by a remote computing device 914-1 to access hub 902 and/or connection manager 934-2, a time/date window for the remote access, a duration of the remote access, among other access information associated with a remote access communication session.

To gain remote access, remote computing device 914-1 requests access to host network 920-2 and/or a particular host computing device 914-2 using access hub 902. The access request can be made by a user of device 914-1 using a web application or can be automatically sent by device 914-1 to hub 902. The access request can be processed at the access hub 902 and can be approved or denied based on access rights or user privileges. Based on the access request, program instructions are executed by the access hub 902 to determine an appropriate connection manager, e.g., 934-2 in this example, through which communications between the private networks 920-1 and 920-2 will be brokered during the remote access communication session. The appropriate connection manager can be determined in a variety of manners such as those previously discussed. Program instructions are also executed by the access hub 902 to request the connection manager 934-2 to configure forwarding as described in FIGS. 7A-7C. That is, the connection manager 934-2 is informed of which IP addresses and ports from which to expect connections.

Program instructions are executed by the access hub 902 to request the first internal node 922-1 and the second internal node 922-2 to open respective encrypted connections 918-1 and 918-2, e.g., SSH tunnels, to the connection manager 934-2 over a suitable information space, e.g., WWW (World Wide Web) 950 as shown. The access hub 902 provides nodes 922-1 and 922-2 with the necessary information, e.g., unpublished IP address and port number, of the connection manager 934-2 to tunnel to. When the encrypted connections 918-1 and 918-2 are successfully established, a secure connection, e.g., communication conduit, from internal node 922-1 to 922-2 through connection manager 934-2 is established.

Program instructions are executed by the access hub 902 to provide remote computing device 914-1 with access information, e.g., an IP address of the connection manager 934-2, a username/password used to access the connection manager 934-2, among other access information that can be used by the computing device 914-1 to communicate with the appropriate host computing device, e.g., computing device 914-2. As discussed above, communications sent from remote computing device 914-1 are sent from internal node 922-1 to connection manager 934-2 through tunnel 918-1, are forwarded through connection manager 934-2 and sent through tunnel 918-2 to node 922-2, and are forwarded from internal node 922-2 to the host computing device 914-2.

Termination of the communication session can occur in various ways as such as those discussed above in connection with FIGS. 7A and 8. For example, program instructions can be executed by remote computing device 914-1 to send a termination message to access hub 902 when the computing device 914-1 has finished communicating with the host computing device 914-2. Program instructions can be executed by the access hub 902 to terminate the remote access session if the session exceeds a predetermined time limit, or if the remote computing device 914-1 has not sent communications to the host computing device 914-2 for a particular time duration, e.g., computing device 914-1 is idle and/or has timed out. The access hub 902 can order teardown of the connections and can request the internal nodes 922-1 and 922-2 to close encrypted connections 918-1 and 918-2, respectively.

The embodiment illustrated in FIG. 9 can be used to quickly facilitate secure remote access between private networks. For instance, internal nodes, e.g., 922-1 and 922-2, can be installed in private networks, e.g., 920-1 and 920-2, with few configuration requirements. The internal nodes 922-1 and 922-2 can be preconfigured to communicate with the access hub 902 upon installation in the private networks 920-1 and 920-2, allowing the private networks 920-1 and 920-2 to establish secure remote communication sessions between each other through use of a connection manager, e.g., connection manager 934-1 and 934-2, as described herein.

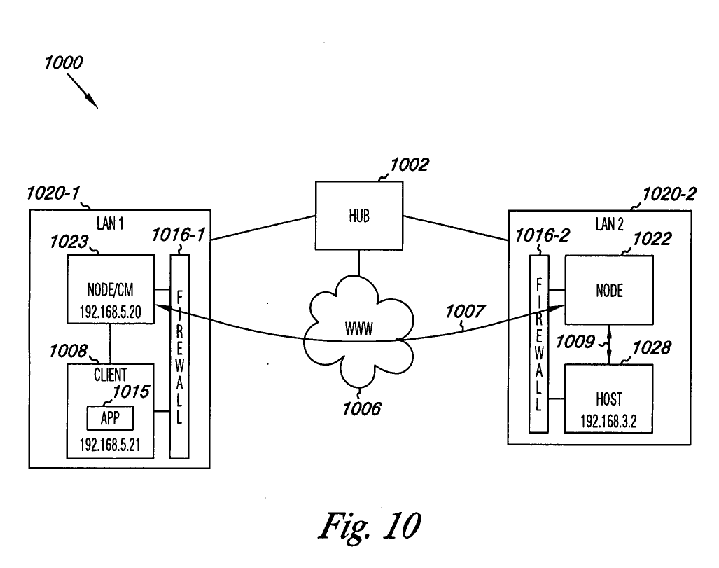

FIG. 10 illustrates another system 1000 for remote access according to an embodiment of the present disclosure. The system illustrated in the embodiment of FIG. 10 includes a remote access hub 1002 in communication with a first private network 1020-1 (shown as LAN 1) and a second private network 1020-2 (shown as LAN2). The first and second private networks, e.g., LAN 1 and LAN 2, can be geographically disparate networks, e.g., separate branch offices, of a particular organization, or can be private networks of separate organizations or companies. As shown in the embodiment illustrated in FIG. 10, the first private network 1020-1 includes a remote computing device 1008 connected to a remote access component 1023 (shown as NODE/CM). The remote computing device 1008 can be a remote computing device such as a remote computing device 708 and/or 808 as described in FIGS. 7A and 8. The NODE/CM 1023 can be an internal node, e.g., node 922-1 of FIG. 9, including program instructions storable in a memory and executable by a processor to perform the functionality of a connection manager, e.g., connection manager 934-2 of FIG. 9. The private network 1020-2 also includes an internal node 1022 as described in connection with FIGS. 7-9 located inside of firewall 1016-2 and connected to a host computing device 1028, e.g., a server, router, or other computing device of network 1020-2. The host computing device 1008 can be a host computing device such as a host computing device 708 and/or 808 as described in FIGS. 7A and 8.

As described further below, including the functionality of a connection manager within the private network 1020-1 can be desirable to network operators, e.g., customers, who may not want communications, e.g., data traffic to terminate on devices external to private network 1020-1 and/or 1020-2. Combining the access node/connection manager functionality in remote access component 1023 can also allow a user of remote computing device 1008 to establish a communication session with a host computing device 1028 in which the anonymity of host device 1028 to 1008 is maintained. For instance, in various embodiments of the present disclosure, remote computing device 1008 is able to communicate with host device 1028 by connecting to a local IP address, e.g., an IP address of the remote access component 1023 which is within network 1020-1 and inside of firewall 1016-1. In such embodiments, the access node/connection manager combination of component 1023 can act as a LAN extension by allowing a local user, e.g., a user of remote computing device 1008, to make a local connection within network 1020-1 that can extend to a geographically removed network, e.g., network 1020-2.

As an example, consider a user of remote computing device 1008 within network 1020-1 that wants to gain secure remote access to a host computing device 1028, having an IP address of 192.168.3.2 as shown, of network 1020-2. In this embodiment, a user of remote computing device 1008 requests access to the host device 1028 by using an application 1015, e.g., a web page hosted by the access hub 1002. The access hub 1002 processes the request and approves or denies the request based on the user privileges and/or access rights of the user of the requesting remote computing device 1008. Based on the access request, program instructions can be executed by the access hub 1002 to provide the remote access component 1023 with configuration information, e.g., an IP address (192.168.5.20 as shown) and other information that can be used to forward communications through component 1023 to internal node 1022 as discussed in connection with FIGS. 7B and 7C.

Program instructions are also executed by the access hub 1002 to request the internal node 1022 within network 1020-2 to open a encrypted connection 1007, e.g., a SSH tunnel, to the NODE/CM 1023 over a suitable information space, e.g., WWW (World Wide Web) 1050 as shown. The access hub 1002 provides internal node 1022 with the necessary information, e.g., unpublished IP address and port number, of the NODE/CM 1023 to tunnel to. Program instructions are then executed by the internal node 1022 to open the encrypted connection 1007 to the NODE/CM 1023 through the firewall 1016-2 using the information provided by access hub 1002. When the encrypted connection 1007 is successfully established, a secure connection, e.g., communication conduit, from the host computing device 1028, located at 192.168.3.2, to NODE/CM 1023 is opened. The secure connection runs through the access node 1022. Communications 1009 between host computing device 1028 and internal node 1022 occur over a suitable protocol, e.g., RDP, VNC, Telnet, which can depend on the type of host computing device 1028 being accessed.

Program instructions are executed by the access hub 1002 to provide remote computing device 1008 with access information, e.g., an appropriate IP address of the NODE/CM 1023. A user of remote computing device 1008 can then communicate with remote host computing device 1028 by using a local IP address (192.168.5.20) of the NODE/CM 1023. That is, program instructions can be executed by the NODE/CM 1023 to receive data traffic from remote computing device 1008 at local address 192.168.5.20 and to forward the data traffic through the encrypted connection 1007 to internal node 1022 such that remote computing device 1008 remains unaware of the IP address (192.168.3.2) of the host computing device 1028. The data traffic is then forwarded by internal node 1022 to the appropriate host computing device, e.g., host computing device 1028 in this case. Teardown of the remote access communication session can occur in various manners as discussed above in connection with FIGS. 7-9.

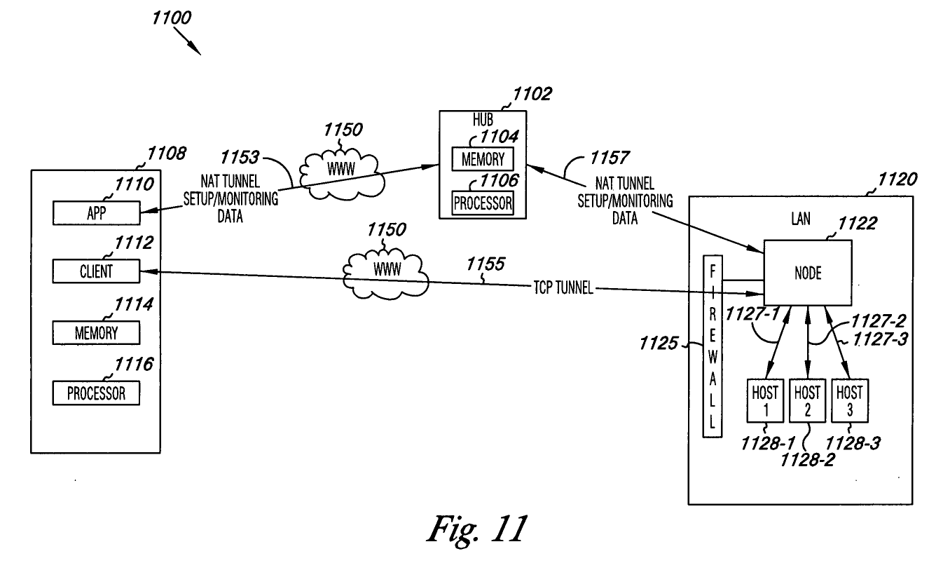

FIG. 11 illustrates another system 1100 for remote access according to an embodiment of the present disclosure. The system illustrated in the embodiment of FIG. 11 can be used to provide remote access to a private network 1120 from a remote computing device 1108 external to the private network 1120 using TCP network address translation (NAT) traversal. As one of ordinary skill will appreciate, TCP NAT traversal can be referred to as STUNT (Simple Traversal of UDP Through NATs and TCP), which is a lightweight protocol that allows applications running behind a NAT to determine external IP and port-binding properties, packet filtering rules and various timeouts associated with TCP connections through the NAT. Knowing these parameters can allow applications to establish TCP communication sessions between two hosts behind firewalls of private networks. As a result various applications such as P2P (peer to peer), among other applications, can work through existing NAT infrastructure without sacrificing the benefits of TCP.

The system 1100 illustrated in the embodiment of FIG. 11 includes an access hub 1102, remote from, and in communication with, a private network 1120 and a remote computing device 1108 located outside of the private network 1120. Embodiments are not so limited, e.g., system 1100 can include any number of remote computing devices, e.g., 1108, private networks, e.g., 1120, and access hubs, e.g., 1102.

In various embodiments, the system 1100 can be used to establish an encrypted connection 1155, e.g., a TCP tunnel as shown in FIG. 11, between a client program 1112 of remote computing device 1108, e.g., a Java client, and an internal node 1122 within network 1120 and located inside firewall 1125. The TCP tunnel 1155 between the client program 1112 and the internal node 1122 can be used during a remote access session to send communications from the remote computing device 1108 to a host/target device within private network 1120, e.g., host/target devices 1128-1, 1128-2, and 1128-3. Host/target devices 1128-1, 1128-2, and 1128-3 can be various computing devices such as web servers, mail servers, routers, etc. During a remote access communication session, communications from client program 1112 are forwarded through internal node 1122 to the appropriate host device 1128-1, 1128-2, and 1128-3 using an appropriate protocol 1127-1, 1127 -2, and 1127-3, respectively. That is, internal node 1122 acts as a proxy for communications to host/target devices 1128-1, 1128-2, and 1128-3. That is, internal node 1122 forwards communications received from client program 1112 to the host/target devices 128-1, 1128-2, and 1128-3.

In the embodiment illustrated in FIG. 11, remote computing device 1108 can request access to private network 1120 and/or a computing device 1128-1, 1128-2, and 1128-3 therein using an application 1110, e.g., a web page or dashboard web application. That is, executable instructions associated with application 1110 can be stored on memory 1114 and executed by processor 1116 to request access to host devices 1128-1, 1128-2, and 1128-3. The application 1110 can be hosted on access hub 1102 and access may be restricted based on access rights of remote device 1108 and/or a user thereof. Computer executable instructions storable on memory 1104 and executable by processor 1106 can be executed on access hub 1102 to process the access request from the remote computing device 1108.

In various embodiments, processing the access request can include sending and receiving NAT tunnel setup information 1153 between the remote computing device 1108 and the access hub 1102. Setting up TCP tunnel 1155 can also include sending and receiving NAT tunnel setup information 1157 between hub 1102 and internal node 1122 over suitable protocols.

Instructions associated with application 1110 can be executed on remote computing device 1108 to request client program 1112, e.g., a Java client, to start NAT traversal. Instructions can also be executed by access hub 1102 to send the internal node 1122 connection information 1157 based on the remote access request. The internal node 1122 can then connect to client program 1112. That is, computer executable instructions can be executed by internal node 1122 to open TCP Tunnel 1155 to remote computing device 1108 through the firewall 1125 from within the private network 1120. Opening the TCP tunnel 1155 establishes the remote access communication session between the remote computing device 1108 and host/target device, e.g., 1128-1, 1128-2, and 1128-3, in which the internal node 1122 forwards communications received through tunnel 1155 to the appropriate host device 1128-1, 1128-2, and 1128-3.

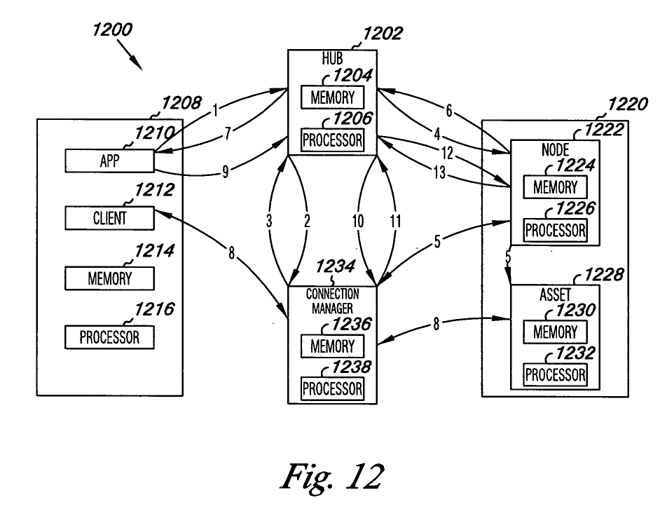

FIG. 12 illustrates a path diagram for a remote access communication session according to an embodiment of the present disclosure. The embodiment illustrated in FIG. 12 shows a system 1200 that includes a remote access hub 1202, e.g., an access hub 702 as described in connection with FIG. 7A. As shown in FIG. 12, the access hub 1202 can include a memory 1204 and a processor 1206 and is located remote from an asset 1228 of an entity 1220 and remote from a computing device 1208, e.g., a remote computing device as described above in FIGS. 7A and 8, for example.

In various embodiments the asset 1228 can be various assets such as a medical device such as a CAT (computed axial tomography) device and/or a MRI (magnetic resonance imaging) device, among other medical devices. The asset 1228 can also include an ATM (automatic teller machine), a HVAC (heating, ventilating, and air-conditioning) device, among various other assets to which remote computing device 1208 can gain remote access as described herein. The asset 1228 in the embodiment of FIG. 12 includes a memory 1230 and a processor 1232, however embodiments are not so limited. That is, in various embodiments, the asset may not include a processor and/or memory resources.

As described in further detail below, the entity 1220 can include an internal node 1222. In some embodiments the internal node 1222 can be executable instructions, e.g., a software agent, storable on a memory of entity 1220 and/or an asset thereof, e.g., asset 1228. In this embodiment the internal node 1222 includes a memory 1224 and processor 1226.

Computer executable instructions can reside on the memory 1204 of access hub 1202 and can be executed by the processor 1206 to perform various actions described herein. For example, the access hub 1202 can be used to instruct/direct the creation and teardown of secure connections, e.g., encrypted connections, associated with remote access communication sessions as described above.

In various embodiments, the access hub 1202 can facilitate the establishment of a remote access communication session between a remote computing device, e.g., 1208, and a target asset, e.g., asset 1228. In various embodiments, the access hub 1202 is in communication with a number of connection managers, e.g., 1234, in order to facilitate the establishment of the remote access communication session as described below. In various embodiments, access hub 1202 brokers communications between a remote computing device 1208 including a client program 1212 as described above in connection with FIG. 7A, a connection manager 1234, and an entity 1220 of system 1200. The access hub 1202 includes executable instructions, e.g., program instructions, storable in the memory 1204 and executable by processor 1206 to load a user interface, e.g., a Dashboard web application or other user interface.

In the embodiment illustrated in FIG. 12, the remote computing device 1208 includes a memory 1214 and a processor 1216. The remote computing device 1208 can access an application 1210, e.g., computer executable instructions that can be executed to request access to an entity 1220 and/or an asset thereof, e.g., asset 1228 and/or various other assets (not shown) within the entity 1220. The application 1210 can be provided to and/or obtained from the access hub 1202, e.g., via a download over the Internet using a web browser when the remote computing device 1208 is given access, e.g., IP address information for the access hub 1202. As one of ordinary skill in the art will appreciate, access to the hub 1202 may be limited to certain users and/or devices 1208 by use of login information, e.g., usernames, passwords, etc. In various embodiments, the application 1210 provides a list of entities, e.g., entity 1220, and/or assets thereof with which remote computing device 1208 can establish a remote access communication session, e.g., gain remote access. The list of entities and/or assets to which the remote computing device 1208 can gain access remotely can vary depending on an access right of a particular device or user. In various embodiments, the remote computing device 1208 includes a client program 1212, e.g., a web browser, a SSH client, a telnet client, a Java applet, etc., used to communicate with an asset, e.g., asset 1228 of entity 1220, once a communication session between the remote computing device 1208 and the target asset 1228 is established as described below.

In the embodiment illustrated in FIG. 12, the entity 1220 includes an internal node 1222 including a memory 1224 and a processor 1226. In some cases, the internal node 1222 can include a hardware device capable of communicating with the access hub in a stateless manner, e.g., J-node 316 of FIG. 3. The internal node 1222 can be connected to various target assets 1228, e.g., medical devices, automated teller machines (ATMs), HVAC equipment, soap dispensing apparatus, and/or computing devices, associated with entity 1220. In the embodiment of FIG. 12, the internal node 1222 is connected to a target asset 1228 that includes a memory 1230 and a processor 1232. However, embodiments are not so limited to this example. In various embodiments, the functionality of an internal node, e.g., internal node 1222, can be provided as computer executable instructions, e.g., a software agent. In such embodiments, the computer executable instructions associated with the internal node 1222 can be stored on a memory of a device within entity 1220 such as asset 1228 or another device of entity 1220. In some embodiments, the internal node 1222 can be a diskless and fanless hardware device such as that described in FIGS. 2-4. In such embodiments, the internal node can be used to facilitate network monitoring and remote access as described herein.

In various embodiments, computer executable instructions, storable in the memory 1230, are executed by the processor 1232 of the internal node 1222 to establish an encrypted connection, e.g., a SSH (secure shell) tunnel, from the internal node 1222 to a connection manager 1234, e.g., a connection manager such as connection manager 734 described in connection with FIG. 7A, when instructed to do so by access hub 1202. That is, when an access request is sent from the remote computing device 1208 to access hub 1202 and authorization confirmed, e.g., via login and password by executable instructions associated with the access hub 1202. The connection manager 1234 can be a publicly accessible server and can host a number of concurrent secure remote access communication sessions. The connection manager 1234 can include processor 1238 and memory resources 1236 with executable instructions stored thereon to perform actions described herein. As described above in connection with FIGS. 7B and 7C, computer executable instructions storable on memory 1236 can be executed by processor 1238 to forward communications from a remote computing device 1208 to the internal node 1222 once an encrypted connection, e.g., encrypted connection 788, as shown in FIG. 7C, has been established between the connection manager 1234 and the internal node 1222.

As illustrated in the embodiment shown in FIG. 12, an application 1210, including computer executable instructions, can be provided to remote computing device 1208, storable in memory 1214, and executed by processor 1216 thereon to perform embodiments herein for requesting access to an entity 1220 and/or a target asset 1228 thereof from the access hub 1202. The computer executable instructions of the application 1210 can be retrieved from memory 1214 and executed by the processor 1216 to send a request (1) for access to a target asset 1228 within an entity 1220 from a remote computing device, e.g., remote computing device 1208. For example, by executing the computer executable instructions of application 1210, a user of remote computing device 1208 can log into an access hub 1202.

As the reader will appreciate, based on the user's access rights and/or privileges, the computer executable instructions and data associated with application 1210 can be loaded to memory from the access hub 1202. The data, e.g., information, can include information on a number of entities, e.g., entity 1220, from which the remote computing device can select to establish a remote access communication session with.

In various embodiments, the access request (1) is processed by computer executable instructions executing on the access hub 1202. Processing the access request (1) can include executing instructions to send a configure forwarding request (2) to connection manager 1234. Based on the configure forwarding request (2), the connection manager 1234 can execute instructions in preparation for routing communications between the remote computing device 1208 requesting remote access and an appropriate entity, e.g., entity 1220 having a host/target asset 1228 to which the remote computing device 1208 has requested access. The connection manager 1234 can execute instructions to send a response (3) to the access hub 1202 which can indicate whether connection manager 1234 is available and/or prepared to route communications when the remote access communication session is established.

In various embodiments, once executable instructions associated with connection manager 1234 have successfully been executed to configure forwarding and to communicate the same to the access hub 1202, the access hub then executes instructions to send a request (4) to the internal node 1222 instructing internal node 1222 to establish a secure connection, e.g., an encrypted connection such as a SSH tunnel, to the connection manager 1234. In some embodiments, instructions on the internal node 1222 can be executed to make web requests such that the internal node 1222 and access hub 1202 communicate in a stateless fashion as described above. For example, the internal node 1222 may periodically check with the access hub 1202 to see if the hub 1202 currently has any communications, e.g., requests that the internal node establish an encrypted connection to a connection manager, for the internal node 1222.

In response to the request (4), the internal node 1222 can direct the execution of instructions to establish an encrypted connection (5), e.g., open a secure tunnel, to the connection manager 1234. One of ordinary skill in the art will appreciate upon reading this disclosure, the manner in which computer executable instructions can be executed in association with an internal node 1222 to establish a secure connection, e.g., a SSH tunnel, to the connection manager 1234. The internal node 1222 can then direct the execution of instructions to send an acknowledge message (6) to the access hub 1202 informing the hub that the encrypted connection, e.g., SSH tunnel, is established. In the embodiment shown in FIG. 12, the access hub 1202 can execute instructions to send a message (7) to the remote computing device 1208 informing the remote computing device 1208 of the IP address for connection manager 1234. The message (7), in effect, indicates that the encrypted connection (5) is established between the connection manager 1234 and the target asset 1228. In various embodiments, the anonymity of the asset 1228 is maintained, e.g., the IP address of the asset 1228 does not have to be known or disclosed to the remote computing device 1208. The message (7) can include access information that can be used by the client program 1212 on the remote computing device 1208 to establish the remote access communication session with the asset 1228. The access information sent from the access hub 1202 to the remote computing device 1208 can include a particular public IP address and port of the connection manager 1234 that can be used by client program 1212 to connect to connection manager 1234.

In various embodiments, connecting to the connection manager 1234 using the access information, e.g., the particular public IP address and port of the connection manager 1234, establishes a remote access communication session between remote computing device 1208 and asset 1228. During a remote access communication session, communications (8) between the remote computing device 1208 and the connection manager 1234 are exchanged through the connection manager 1234 to the asset 1228 via the encrypted connection (5), e.g., SSH tunnel or other encrypted connection. In such embodiments, instructions can be executed by the internal node 1222 to forward communications (8), forwarded to the internal node 1222 from the connection manager 1234, to the asset 1228 via the encrypted connection (5).

According to embodiments, the encrypted connection (5) between the connection manager 1234 and the asset 1228 has been facilitated by the internal node 1222. In various embodiments of the present disclosure, the encrypted connection (5) is only established, e.g., opened, when access is requested by a remote computing device 1208 and the access request is approved by the access hub 1202. That is, the internal node 1222 does not constantly have a port open, e.g., “listening,” for web requests. In this manner, such embodiments are less susceptible to security breaches than prior remote access solutions that constantly expose a entity to Internet connections via inbound web requests, e.g., SSL web requests on port 443 for example.

As described herein, in various embodiments, the communication session is an anonymous communication session. That is, the remote computing device 1208 remains unaware of the location, e.g., IP address, of the asset 1228. Maintaining the anonymity of the asset 1228 can provide various benefits related to privacy and security. For example, an organization may wish to allow a third party IT technician to remotely access an asset, e.g., asset 1228, of the organization in order to perform a maintenance task on the asset 1228 or another asset of entity 1220. In such circumstances, the organization may not want the remote third party to know the IP address and/or physical location of the entity 1220 and/or asset 1228 being accessed.

According to various embodiments, and as described above in connection with FIGS. 8-11, a remote access communication session between a remote computing device, e.g., remote computing device 1208, and a target asset, e.g., asset 1228, can be terminated in various manners. In the embodiment illustrated in FIG. 12, the remote computing device 1208 executes instructions associated with application 1210 to send a session termination message (9) to the access hub 1202 which indicates that the remote communication session can be terminated, and that the encrypted connection between connection manager 1234 and the internal node 1222, e.g., the SSH tunnel, can be closed.

In this embodiment, the access hub 1202 executes instructions to send a message (10) to connection manager 1234 for the connection manager 1234 to teardown the connection between the client program 1212 and connection manager 1234, e.g., connection 778 shown in FIG. 7C. The connection manager 1234 then executes instructions to send a response (11) to indicate whether the connection was closed successfully. In this embodiment, the access hub 1202 also executes instructions to send a message (12) to the internal node 1222 to inform the internal node 1222 to close the encrypted connection, e.g., encrypted connection 788 shown in FIG. 7C, between the internal node 1222 and the connection manager 1234. The internal node 1222 then executes instructions to send a response (13) to the access hub 1202 which indicates whether the encrypted connection, e.g., encrypted connection 788 shown in FIG. 7C, has been torn down, e.g., closed, successfully.

As described further below, various embodiments of the present disclosure allow for publicly available temporary secure remote access to an asset 1228 using a publicly accessible connection manager 1234 and an internal node 1222 within the entity 1220 that is capable of sending outbound requests to the connection manager 1234 to establish an encrypted connection between the internal node 1222 and the connection manager 1234.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the invention. It is to be understood that the above description has been made in an illustrative fashion, and not a restrictive one. Combination of the above embodiments, and other embodiments not specifically described herein will be apparent to those of skill in the art upon reviewing the above description. The scope of the various embodiments of the invention includes any other applications in which the above structures and methods are used. Therefore, the scope of various embodiments of the invention should be determined with reference to the appended claims, along with the full range of equivalents to which such claims are entitled.

For example, the embodiments described above can be used for monitoring and data collection on any type of system. These systems can be computer related or even machines not associated with IT such as a HVAC (heating ventilation and air conditioning) system. The embodiments can also be used to gather business process parameters in a real time fashion and display them on a web browser anywhere in the world. The embodiments can be used as a diagnostic tool shipped out to a customer to gather statistics, which may help determine if a future install is feasible. The embodiments can be used as an alternative method to reach the internet through the use of the internal monitoring device's cellular and/or analog modem.

In the foregoing Detailed Description, various features are grouped together in a single embodiment for the purpose of streamlining the disclosure. This method of disclosure is not to be interpreted as reflecting an intention that the embodiments of the invention require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A method for remote access, comprising:
requesting access to a first device of a private network from a second device remote to the private network, the private network including an internal node inside of a firewall of the private network;
processing the access request at an access hub remote to the private network;
using the internal node to open an encrypted connection through the firewall to a connection manager outside of the private network based on the access request;
providing access information from the access hub to the second device based on the access request; and
establishing a communication session in which communications between the second device and the first device are forwarded through the connection manager and the internal node by using the encrypted connection.

2. The method of claim 1, wherein providing access information includes providing access information that maintains an anonymity of the first device to the second device and enables the second device to connect to the connection manager.

3. The method of claim 1, wherein providing access information includes providing the second device with a particular IP address and port of the connection manager, the connection manager having a number of associated public IP addresses, and wherein the second device remains unaware of an IP address of the first device during the communication session.

4. The method of claim 3, wherein establishing the communication session includes establishing a temporary anonymous communication session that is only accessible to the second device.

5. The method of claim 1, wherein the method includes providing the internal node with an unpublished IP address of the connection manager, the unpublished IP address provided by the access hub, and wherein the method includes opening the encrypted connection to the connection manager using an the unpublished IP address.

6. The method of claim 1, wherein the method includes using a web page on the access hub that is viewable to a user of the second device to make the access request.

7. The method of claim 1, wherein the method includes closing the encrypted connection upon the expiration of a particular time duration.

8. The method of claim 1, wherein opening the encrypted connection includes opening a secure shell (SSH) tunnel.

9. The method of claim 1, wherein the method includes providing the internal node in the form of executable instructions on a computer readable medium accessible by a processor resource capable of executing the instructions.

10. A method for remote access, comprising:
requesting access to a private network from a computing device remote to the private network, the private network including an internal node inside of a firewall of the private network;
processing the access request at an access hub remote to the private network,
using the internal node to open an encrypted connection through the firewall to a connection manager outside of the private network based on the access request, wherein the connection manager hosts a web portal;
providing access information from the access hub to the computing device based on the access request, wherein the access information includes an IP address associated with the connection manager and a URL associated with the web portal;
establishing a communication session between the computing device and the private network by using the web portal to send communications from the device to the private network using the encrypted connection.

11. The method of claim 10, wherein establishing the communication session includes using a web portal supporting a number of protocols that are used to communicate with a number of computing devices connected to the internal node within the private network.

12. The method of claim 10, wherein requesting access includes requesting access to a number of private networks having an internal node inside a firewall of the number of networks, and wherein the web portal includes a list of the number of private networks from which a user of the computing device can select to establish the communication session.

13. The method of claim 10, wherein establishing the communication session includes establishing an anonymous communication session that maintains the anonymity of the private network to the computing device during the communication session.

14. The method of claim 10, wherein the method includes establishing the encrypted connection for a predetermined time.

15. The method of claim 10, wherein the method includes generating an audit log of information associated with the communication session.

16. The method of claim 15, wherein generating the audit log includes generating an audit log that includes information from the group of:
a start time of the communication session;
an end time of the communication session;
a time duration of the communication session;
the communications sent from the computing device via the web portal during the communication session;
an IP address of the computing device; and
information associated with a user of the computing device during the communication session.

17. The method of claim 10, wherein opening the encrypted connection includes establishing a virtual private network connection between the connection manager and the internal node.

18. The method of claim 10, wherein opening the encrypted connection includes opening a secure tunnel from the internal node to a particular port of the connection manager, information about the particular port provided by the access hub.

19. A method for remote access, comprising:
requesting access to a first device of a first network from a second device of a second network different from the first network, the first network having a first internal node inside a firewall of the first network and the second network having a second internal node inside a firewall of the second network;
processing the access request at an access hub remote to the first and the second network;
using the first internal node to establish a first encrypted connection from within the first network through the firewall of the first network to a connection manager outside of the first and second network;
using the second internal node to establish a second encrypted connection from within the second network through the firewall of the second network to the connection manager;
wherein establishing the first and the second encrypted connection establishes a secure connection between the first device and the second device, the secure connection passing through the first and the second internal node.

20. The method of claim 19, wherein the method includes providing configuration information to the connection manager from the remote access hub, the configuration information including an IP address of the second device and a port to be used by the connection manager to forward communications therethrough.

21. The method of claim 19, wherein the method includes using the secure connection to send communications between the first and second device, and wherein the anonymity of the first device to the second device is maintained.

22. The method to claim 19, wherein the method includes using the hub to select a connection manager from a number of connection managers outside of the first and the second network based on an IP address of the first device and an IP address of the second device.

23. A method for remote access, comprising:
providing an invitation to access a first computing device located within a private network, the invitation provided from a data center to a second computing device, wherein the second computing device is outside the private network, and wherein the invitation includes a time window within which the second computing device is allowed to access the first computing device;
sending an access request, within the time window, to access the first computing device, the request sent from the second computing device to the data center and processed at the data center;
providing access information from the data center to the second computing device, the access information including an IP address associated with a connection manager, wherein the connection manager is outside the private network;
using an internal node connected to the first computing device and inside a firewall of the private network to open an encrypted connection through the firewall to the connection manager;
establishing a temporary remote access communication session to the first computing device from the second computing device by connecting to the connection manager from the second computing device using the provided IP address.

24. The method of claim 23, wherein connecting to the connection manager from the second computing device includes connecting to a web portal hosted on the connection manager.

25. The method of claim 24, wherein the method includes using the web portal to send communications from the second computing device to the internal node through the encrypted connection during the temporary remote access communication session.

26. The method of claim 25, wherein the method includes forwarding the communications from the internal node to the first computing device, and wherein an anonymity of the first computing device to the second computing device is maintained.

27. The method of claim 23, wherein the method includes closing the encrypted connection upon an expiration of the time window.

28. The method of claim 27, wherein the method includes terminating the temporary remote access communication session prior to the expiration of the time window when the second device exceeds an authorized scope of activity.

29. The method of claim 27, wherein the method includes terminating the temporary remote access communication session prior to the expiration of the time window if the temporary remote access communication session has exceeded a predetermined time limit.

30. The method of claim 27, wherein the method includes terminating the temporary remote access communication session prior to the expiration of the time window if a particular time duration has passed since a last communication sent by the second computing device.

31. The method of claim 23, wherein the method includes providing the invitation to the second computing device in an email message, and wherein opening the email message sends information, including an IP address of the second computing device, to the data center.

32. A method for remote access, comprising:
requesting access to a first computing device of a first network from a second computing device of a second network different from the first network, the first network having a first internal node inside a firewall of the first network and the second network having a second internal node inside a firewall of the second network;
processing the access request at an access hub remote to the first and the second network;
using the first internal node to establish an encrypted connection from the first internal node to the second internal node; and
wherein the second internal node has executable instructions storable on a memory thereof and executable by a processor thereof to configure forwarding of communications between the first computing device and the second computing device via the encrypted connection.

33. The method of claim 32, wherein the method includes making an outbound request from the first internal node to the access hub to determine whether the second device made the access request to the first computing device.

34. The method of claim 32, wherein establishing the encrypted connection includes establishes a secure communication session between the first computing device and the second computing device, and wherein communications between the first computing device and second computing device are forwarded through the first internal node and the second internal node.

35. The method of claim 32, wherein the method includes:
making only outbound requests from the first internal node to the access hub; and
making an outbound request to from the first internal node to the access hub to determine whether to teardown the encrypted connection.

36. The method of claim 32, wherein configuring forwarding includes providing the second computing device with a local IP address of the second internal node to be used by the second computing device to send communications to the first computing device while maintaining the anonymity of the first computing device to the second computing device.

37. A system for remote access, comprising:
a first private network including a first computing device in communication with an internal node inside of a firewall of the first private network, the internal node including executable instructions storable thereon that can be executed to make outbound requests through the firewall to a publicly accessible connection manager remote from the first private network to open an encrypted connection between the connection manager and the internal node; and
a data center remote from the first private network, the data center including executable instructions storable thereon and executable by a processor thereof to:
process requests for remote access to the first computing device received from a second computing device outside the first private network; and
provide access information to the second computing device used by the second computing device to connect to the connection manager establishing a communication session between the second computing device and the first computing device, wherein communications between second device and the first device are forwarded through the connection manager and the internal node by using the encrypted connection.

38. The system of claim 37, wherein the communication session is an anonymous communication session.

39. The system of claim 37, wherein the system includes:
a number of private networks, wherein each private network has a number of internal computing devices each connected to an internal node behind a firewall of the number of networks; and
a number of publicly accessible connection managers remote from the number of private networks;
wherein the data center includes logic to determine an appropriate connection manager of the number of connection mangers to which the second computing device can connect to establish the communication session.

40. The system of claim 39, wherein the appropriate connection manager is determined based on at least one of:
a location of the second device and the node device based on an IP address of the second device and an IP address of the internal node;
a preference of a user of the second device; and
a round trip time to the second device and the internal node.

41. The system of claim 37, wherein the connection manager hosts a web portal accessible to the second device to transmit communications to the first device through the internal node.

42. The system of claim 41, wherein the connection manager includes logic to decrypt information input to the web portal and to send the decrypted information to the data center in order to audit the information.

43. The system of claim 37, wherein the internal node includes logic to communicate internal network monitoring information of the private network to the data center in a stateless manner.

44. The system of claim 43, wherein the internal node includes a diskless and fanless hardware device.

45. A method for remote access, comprising:
requesting access to a first computing device of a private network from a second computing device remote to the private network, the private network including an internal node inside of a firewall of the private network;
processing the access request at an access hub remote to the private network;
providing connection information from the access hub to the internal node and to the connection manager based on the access request;
establishing a remote access communication session between the first computing device and the second computing device by opening an encrypted connection between the internal node and the second computing device based on the connection information;
forwarding, through the internal node, communications sent during the remote access communication session between the first computing device and the second computing device.

46. The method of claim 45, wherein opening the encrypted connection includes opening a secure tunnel based on network address translation (NAT) traversal.
